(19) United States
(12) Patent Application Publication
(10) Pub. No.: US 2026/0273960 A1
(43) Pub. Date: Sep. 17, 2026

(54) Liquid Ejecting Apparatus And Method Of Controlling Heating Circuit

(71) Applicant: SEIKO EPSON CORPORATION, Tokyo (JP)

(72) Inventor: Atsushi UMEDA, Azumino (JP)

(21) Appl. No.: 19/562,010

(22) Filed: Mar. 10, 2026

(30) Foreign Application Priority Data
Mar. 11, 2025 (JP) 2025-038268

(51) Int. Cl. B41J 11/00; H05B 3/00

(52) U.S. Cl. CPC B41J 11/0015; H05B 3/0019

(57) ABSTRACT

A liquid ejecting apparatus includes a supply circuit that supplies driving power to a heating circuit in accordance with a result of detection by a detection circuit that detects a temperature of the heating circuit. The supply circuit includes a switch circuit, and a switching control circuit that controls the switch circuit in accordance with the result of the detection. The switching control circuit switches the switch circuit from a state in which the driving power is not supplied to the heating circuit to a state in which the driving power is supplied to the heating circuit in a first control period, and switches the switch circuit from the state in which the driving power is supplied to the heating circuit to the state in which the driving power is not supplied to the heating circuit in a second control period that is continuous to the first control period.

The present application is based on, and claims priority from JP Application Serial Number 2025-038268, filed Mar. 11, 2025, the disclosure of which is hereby incorporated by reference herein in its entirety.

### BACKGROUND

### 1. Technical Field

The present disclosure relates to a liquid ejecting apparatus and a method of controlling a heating circuit.

### 2. Related Art

JP-A-2013-163336 discloses a printer (liquid ejecting apparatus) that forms an image on a medium by ejecting liquid onto the medium and that includes a drying device such as a heater.

In a liquid ejecting apparatus having a heater as described in JP-A-2013-163336, the amount of current drawn into the liquid ejecting apparatus instantaneously increases at the timing at which driving power is supplied to the heater. In this case, a voltage value of commercial power may decrease due to an effect of impedance of a propagation path through which the commercial power is supplied to the liquid ejecting apparatus. In addition, the heater used in the liquid ejecting apparatus may be intermittently driven from the viewpoint of controlling the temperature to be constant with low power consumption. In this case, the amount of current drawn into the liquid ejecting apparatus is intermittently increased in synchronization with the intermittent driving of the heater. Therefore, the voltage value of the commercial power supplied to the liquid ejecting apparatus periodically fluctuates. Such a periodic voltage fluctuation that occurs in the commercial power may cause a flicker in a lighting apparatus coupled to the same power supply system, and the flicker may cause discomfort to a person. Therefore, for the liquid ejecting apparatus including the heater to which the commercial power is supplied, it is required to reduce the possibility that a person may feel discomfort due to a flicker occurring in the lighting apparatus coupled to the power supply system to which the liquid ejecting apparatus is coupled when the heater is driven.

However, in JP-A-2013-163336, sufficient consideration is not given to this point, and there is room for improvement.

### SUMMARY

According to an aspect of the present disclosure, there is provided a liquid ejecting apparatus including: a transport unit that transports a medium; a print head that ejects liquid onto the medium; a heating circuit that heats the medium; a detection circuit that detects a temperature of the heating circuit; and a supply circuit that supplies driving power to the heating circuit in accordance with a result of the detection by the detection circuit, wherein the supply circuit includes a switch circuit that switches whether to supply the driving power to the heating circuit, and a switching control circuit that controls the switch circuit in accordance with the result of the detection in each of a plurality of control periods, and the switching control circuit switches the switch circuit from a state in which the driving power is not supplied to the heating circuit to a state in which the driving power is supplied to the heating circuit in a first control period among the plurality of control periods, and switches the switch circuit from the state in which the driving power is supplied to the heating circuit to the state in which the driving power is not supplied to the heating circuit in a second control period that is among the plurality of control periods and is continuous to the first control period.

According to an aspect of the present disclosure, there is provided a method of controlling a heating circuit that heats a medium in a liquid ejecting apparatus that ejects liquid onto the medium, the method including: detecting a temperature of the heating circuit; and supplying driving power to the heating circuit in accordance with a result of the detecting in each of a plurality of control periods, wherein the supplying includes first supplying in which a state in which the driving power is not supplied to the heating circuit is switched to a state in which the driving power is supplied to the heating circuit in a first control period among the plurality of control periods, and second supplying in which the state in which the driving power is supplied to the heating circuit is switched to the state in which the driving power is not supplied to the heating circuit in a second control period that is among the plurality of control periods and is continuous to the first control period.

### BRIEF DESCRIPTION OF THE DRAWINGS

FIG. 1 is a diagram illustrating a schematic configuration of a liquid ejecting apparatus.

FIG. 2 is a diagram illustrating an example of a functional configuration of the liquid ejecting apparatus.

FIG. 3 is a diagram illustrating a configuration of a heater driving unit.

FIG. 4 is a diagram illustrating an example of an operation of a switching circuit.

FIG. 5 is a diagram illustrating an example of a method of controlling the temperature of a heater.

FIG. 6 is a diagram illustrating an example of a method of controlling the heater.

FIG. 7 is a diagram illustrating an example of a method of controlling the heater in a first supply process.

FIG. 8 is a diagram illustrating an example of a method of controlling the heater in a second supply process.

FIG. 9 is a diagram illustrating the relationship between a frequency of a flicker that occurs in a lighting apparatus and visual sensitivity perceived by a person.

### DESCRIPTION OF EMBODIMENTS

Hereinafter, preferred embodiments of the present disclosure will be described with reference to the drawings. The drawings to be used are for convenience of description. The embodiments described below do not unduly limit the contents of the present disclosure described in the scope of claims. In addition, all configurations described below are not necessarily essential components of the present disclosure.

### 1. CONFIGURATION OF LIQUID EJECTING APPARATUS

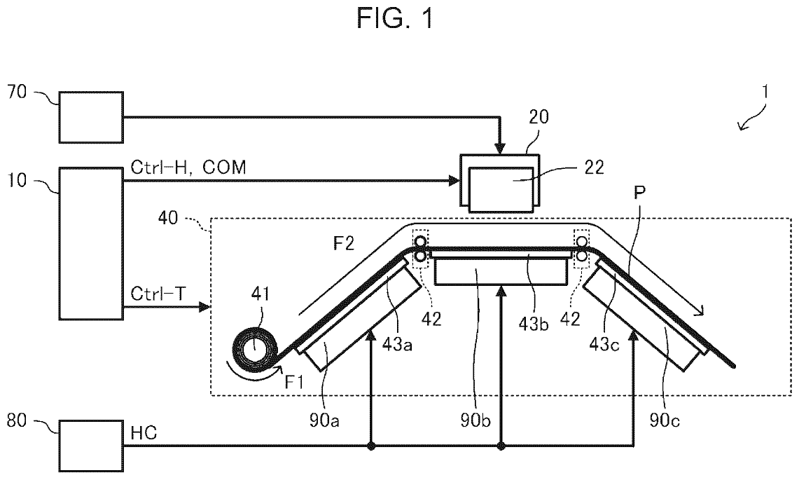

FIG. 1 is a diagram illustrating a schematic configuration of a liquid ejecting apparatus 1. The liquid ejecting apparatus 1 according to the present embodiment is a so-called line printing type ink jet printer in which a head unit 20 includes a plurality of print heads 22 arranged in succession across a length greater than or equal to a width of a medium P and in which each of the plurality of print heads 22 ejects ink onto the medium P transported by a transport unit 40 to form a desired image on the medium P. The liquid ejecting apparatus 1 is not limited to the line printing type ink jet printer, and may be a serial printing type ink jet printer. The liquid ejecting apparatus 1 is not limited to an ink jet printer, and may be a color material ejecting apparatus that is used for manufacturing a color filter of a liquid crystal display or the like, an electrode material ejecting apparatus that is used for forming an electrode of an organic EL display, a field emission display (FED), or the like, a bio-organic material ejecting apparatus that is used for manufacturing a biochip, a three-dimensional shaping apparatus that generates a three-dimensional object, a textile printing apparatus that dyes a cloth, or the like.

As illustrated in FIG. 1, the liquid ejecting apparatus 1 includes a control unit 10, the head unit 20, the transport unit 40, an ink container 70, a heater driving unit 80, and heaters 90a, 90b, and 90c.

A plurality of types of ink to be ejected onto the medium P are stored in the ink container 70. As the ink container 70, an ink cartridge, a bag-shaped ink pack formed of a flexible film, an ink tank that can be refilled with ink, or the like can be used.

The control unit 10 includes a processing circuit such as a central processing unit (CPU) or a field programmable gate array (FPGA), and a storage circuit such as a semiconductor memory. The control unit 10 generates and outputs a signal for controlling each element of the liquid ejecting apparatus 1 including the head unit 20 in accordance with an image information signal input from an external apparatus.

The head unit 20 includes the plurality of print heads 22. A control signal Ctrl-H and a drive signal COM are output by the control unit 10 and input to each of the plurality of print heads 22. The ink stored in the ink container 70 is supplied to each of the plurality of print heads 22. Each of the plurality of print heads 22 ejects the ink supplied from the ink container 70 onto the medium P, based on the input control signal Ctrl-H and the input drive signal COM.

The transport unit 40 includes a feed motor 41, a plurality of pairs of transport rollers 42, and support members 43a, 43b, and 43c.

The feed motor 41 is rotationally driven in a rotation direction F1 based on a control signal Ctrl-T input from the control unit 10. The medium P is fed by the rotational driving of the feed motor 41 from a roll body around which the medium P is wound in a roll shape.

Each of the plurality of pairs of transport rollers 42 includes a drive roller that is driven based on the control signal Ctrl-T, and a driven roller that is driven in accordance with the driving of the drive roller. Each of the plurality of pairs of transport rollers 42 holds the medium P between the drive roller and the driven roller. When the drive roller is driven based on the control signal Ctrl-T, the medium P held between the drive roller and the driven roller is transported in a transport direction F2.

The support members 43a, 43b, and 43c support the medium P transported in the transport direction F2. Specifically, the support members 43a, 43b, and 43c are positioned in the order of the support member 43a, the support member 43b, and the support member 43c from the upstream side to the downstream side in the transport direction F2. In this case, the support member 43b is positioned to face at least one of the plurality of print heads 22 in a direction in which the ink is ejected from the plurality of print heads 22. That is, the support member 43b functions as a platen that supports the medium P during the ejection of the ink, the support member 43a positioned upstream of the support member 43b supports the medium P before the ink is ejected, and the support member 43c positioned downstream of the support member 43b supports the medium P after the ink is ejected.

The heater driving unit 80 generates a drive signal HC for driving each of the heaters 90a, 90b, and 90c and outputs the drive signal HC to the heaters 90a, 90b, and 90c. Each of the heaters 90a, 90b, and 90c includes a heating element that has a resistance load and that generates heat in accordance with at least one of a voltage value and a current value of the input drive signal HC. The heaters 90a, 90b, and 90c heat the medium P supported by the support members 43a, 43b, and 43c, respectively. Each of the heaters 90a, 90b, and 90c may include a resistance load, such as a nichrome line, as the heating element.

The heater 90a is positioned corresponding to the support member 43a. That is, the heater 90a is positioned upstream of the print heads 22 in the transport direction F2 in a transport path for the medium P transported by the transport unit 40. Accordingly, the medium P supported by the support member 43a is heated by the heater 90a generating heat in response to the drive signal HC. As a result, the possibility that cockling may occur in the medium P onto which the ink is ejected is reduced. The heater 90a may be referred to as a preheater.

The heater 90b is positioned corresponding to the support member 43b. That is, the heater 90b is positioned such that at least a portion of the heater 90b overlaps the print heads 22 as viewed from a direction orthogonal to the transport direction F2 and orthogonal to the transport path for the medium P transported by the transport unit 40. The medium P supported by the support member 43b is heated by the heater 90b generating heat in response to the drive signal HC. As a result, the fixability of the ink ejected onto the medium P is improved, and the possibility that graininess may occur in the image formed on the medium P is reduced. The heater 90b may be referred to as a platen heater.

The heater 90c is positioned corresponding to the support member 43c. That is, the heater 90c is positioned downstream of the print heads 22 in the transport direction F2 in the transport path for the medium P transported by the transport unit 40. The medium P supported by the support member 43c is heated by the heater 90c generating heat in response to the drive signal HC. As a result, the possibility that the ink that has landed on the medium P may be transferred to a rear surface of the medium P is reduced, and the possibility that the medium P may be wrinkled is reduced. The heater 90c may be referred to as an after-heater.

In the liquid ejecting apparatus 1 configured as described above, under control by the control unit 10, the transport unit 40 transports the medium P in the transport direction F2 and the plurality of print heads 22 included in the head unit 20 eject the ink onto the medium P. In this case, the heaters 90a, 90b, and 90c generate heat to heat the medium P under control by the heater driving unit 80, so that the quality of the image formed on the medium P is improved.

In FIG. 1, so-called roll paper wound in a roll shape around the roll body and pulled out from the roll body is used as the medium P as an example, but the medium P may be so-called sheet paper cut into a predetermined size. Further, the heaters 90a, 90b, and 90c and the corresponding support members 43a, 43b, and 43c may be integrally formed. That is, the heaters 90a, 90b, and 90c may also serve as the corresponding support members 43a, 43b, and 43c.

### 2. FUNCTIONAL CONFIGURATION OF LIQUID EJECTION APPARATUS

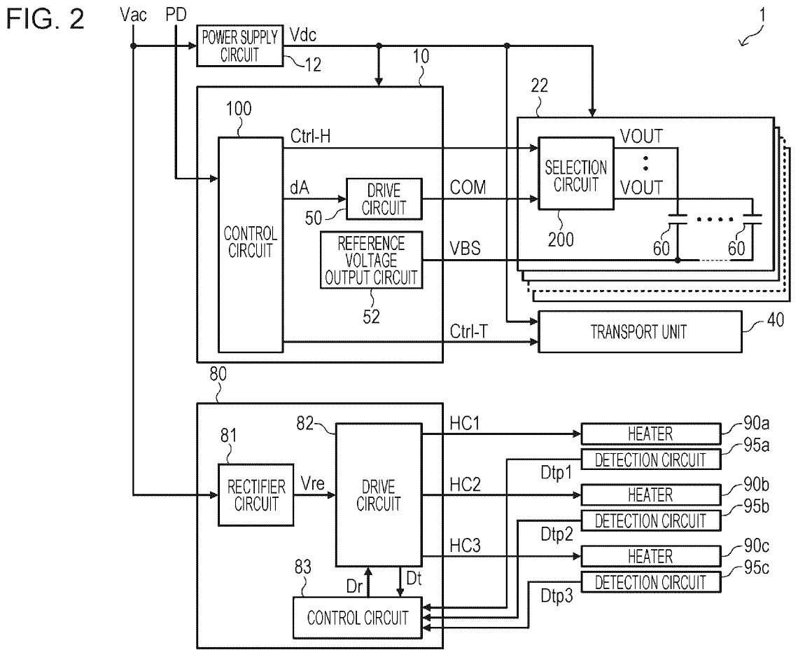

Next, a functional configuration of the liquid ejecting apparatus 1 will be described. FIG. 2 is a diagram illustrating an example of the functional configuration of the liquid ejecting apparatus 1. As illustrated in FIG. 2, the liquid ejecting apparatus 1 includes the control unit 10, a power supply circuit 12, the plurality of print heads 22, the transport unit 40, the heater driving unit 80, the heaters 90a, 90b, and 90c, and detection circuits 95a, 95b, and 95c. The plurality of print heads 22 have the same configuration. Therefore, the following description may focus on one print head 22 among the plurality of print heads 22.

The power supply circuit 12 generates, from a voltage signal Vac that is an alternating current voltage signal of commercial power or the like supplied to the liquid ejecting apparatus 1, a voltage signal Vdc that has a constant voltage of, for example, 42 V and that is a direct current voltage signal that is used in various components including the control unit 10, the plurality of print heads 22, and the transport unit 40 included in the liquid ejecting apparatus 1. The power supply circuit 12 outputs the generated voltage signal Vdc. The power supply circuit 12 includes, for example, an existing AC/DC converter such as a flyback converter. The power supply circuit 12 may output, as the voltage signal Vdc, a direct current voltage signal having a plurality of voltage values that are used in the various components of the liquid ejecting apparatus 1. That is, in addition to the direct current voltage signal having a voltage of 42 V, the power supply circuit 12 may generate a direct current voltage signal having a plurality of voltage values such as 21 V, 7.5 V, 5 V, and 3.3 V, and output the direct current voltage signal as the voltage signal Vdc. In this case, the power supply circuit 12 may include, in addition to the AC/DC converter, one or more DC/DC converters that change the voltage value of the direct current voltage signal output by the AC/DC converter. In the following description, it is assumed that the voltage signal Vac supplied to the liquid ejecting apparatus 1 is an alternating current voltage signal at 50 Hz or 60 Hz, but the frequency of the voltage signal Vac supplied to the liquid ejecting apparatus 1 is not limited thereto.

The control unit 10 includes a drive circuit 50, a reference voltage output circuit 52, and a control circuit 100. The control circuit 100 includes, for example, a processing circuit such as a CPU or an FPGA, and a storage circuit such as a semiconductor memory. An image information signal PD including image data and the like is input to the control circuit 100 from an external apparatus coupled to the liquid ejecting apparatus 1. The voltage signal Vdc is input to the control circuit 100. The control circuit 100 is driven by the input voltage signal Vdc as driving power, generates, based on the input image information signal PD, various signals for controlling the liquid ejecting apparatus 1, and outputs the generated signals to corresponding components.

Specifically, the control circuit 100 generates, based on the input image information signal PD, the control signal Ctrl-T for controlling the transport of the medium P and outputs the control signal Ctrl-T to the transport unit 40. The transport unit 40 is driven by the voltage signal Vdc as driving power and operates in response to the input control signal Ctrl-T to transport the medium P in the transport direction F2.

In addition, the control circuit 100 generates, based on the input image information signal PD and the transport position of the medium P, the control signal Ctrl-H for controlling the timing of ejecting ink from the print head 22, and outputs the control signal Ctrl-H to the corresponding print head 22.

Further, the control circuit 100 outputs, to the drive circuit 50, a base drive signal dA that is a digital signal. The drive circuit 50 performs digital-to-analog signal conversion to convert the input base drive signal dA into an analog signal, then performs class-D amplification on the converted analog signal based on the voltage signal Vdc to generate the drive signal COM, and outputs the drive signal COM to the print head 22. The drive circuit 50 may generate a plurality of drive signals COM corresponding to the plurality of respective print heads 22 and output the drive signals COM to the corresponding print heads 22, or may generate a drive signal COM common to the plurality of print heads 22 and output the drive signal COM to the plurality of print heads 22. Further, the drive circuit 50 may be configured to generate a drive signal COM by performing class-A amplification, class-B amplification, or class-AB amplification instead of or in addition to class-D amplification as long as the drive circuit 50 can amplify a signal waveform defined by the base drive signal dA. Further, the base drive signal dA may be an analog signal as long as the base drive signal dA defines the signal waveform of the drive signal COM.

The reference voltage output circuit 52 generates a voltage signal VBS by stepping down or stepping up the voltage value of the voltage signal Vdc, and outputs the voltage signal VBS to the print head 22. The voltage signal VBS is a signal having a reference electrical potential for driving piezoelectric elements 60 (described later) included in the print head 22, and may be, for example, a direct current voltage signal having a constant electrical potential of 5.5 V, 6 V, or the like.

The print head 22 includes a selection circuit 200 and the plurality of piezoelectric elements 60. The control signal Ctrl-H and the drive signal COM are input to the selection circuit 200. The selection circuit 200 generates, based on the control signal Ctrl-H, a drive signal VOUT corresponding to each of the plurality of piezoelectric elements 60 by selecting or not selecting the signal waveform included in the drive signal COM for each of the plurality of piezoelectric elements 60. Then, the selection circuit 200 supplies each of the generated drive signals VOUT to one end of a corresponding one of the piezoelectric elements 60. Further, the voltage signal VBS is commonly supplied to the other ends of the plurality of piezoelectric elements 60. In this case, each of the plurality of piezoelectric elements 60 is deformed according to a difference in electrical potential between the drive signal VOUT input to the one end and the voltage signal VBS input to the other end. Ink in an amount corresponding to the amount of the deformation of each of the piezoelectric elements 60 is ejected from a nozzle corresponding to the piezoelectric element 60. That is, ink in an amount corresponding to the amount of the deformation of each of the piezoelectric elements 60 is ejected from the print head 22.

The voltage signal Vac is input to the heater driving unit 80. The heater driving unit 80 generates drive signals HC1, HC2, and HC3 as drive signals HC from the input voltage signal Vac, and outputs the drive signals HC1, HC2, and HC3 to the heaters 90a, 90b, and 90c, respectively.

The drive signal HC1 as the drive signal HC is input to the heater 90a. The heater 90a generates heat in accordance with at least one of a voltage value and a current value of the input drive signal HC1. The drive signal HC2 as the drive signal HC is input to the heater 90b. The heater 90b generates heat in accordance with at least one of a voltage value and a current value of the input drive signal HC2. The drive signal HC3 as the drive signal HC is input to the heater 90c. The heater 90c generates heat in accordance with at least one of a voltage value and a current value of the input drive signal HC3.

The detection circuit 95a is positioned near the heater 90a and detects the temperature of the heater 90a. Then, the detection circuit 95a generates a detection signal Dtp1 corresponding to the temperature of the heater 90a and outputs the detection signal Dtp1 to the heater driving unit 80. The detection circuit 95b is positioned near the heater 90b and detects the temperature of the heater 90b. The detection circuit 95b generates a detection signal Dtp2 corresponding to the temperature of the heater 90b and outputs the detection signal Dtp2 to the heater driving unit 80. The detection circuit 95c is positioned near the heater 90c and detects the temperature of the heater 90c. The detection circuit 95c generates a detection signal Dtp3 corresponding to the temperature of the heater 90c and outputs the detection signal Dtp3 to the heater driving unit 80. Each of the detection circuits 95a, 95b, and 95c may include a circuit element whose characteristics change according to the temperature and that is, for example, a thermistor element or the like.

The heater driving unit 80 includes a rectifier circuit 81, a drive circuit 82, and a control circuit 83.

The voltage signal Vac input to the heater driving unit 80 is input to the rectifier circuit 81. The rectifier circuit 81 generates a voltage signal Vre by performing full-wave rectification on the voltage signal Vac, and outputs the voltage signal Vre to the drive circuit 82. The voltage signal Vre output by the rectifier circuit 81 is not limited to the signal obtained by performing the full-wave rectification on the voltage signal Vac, and may be a signal obtained by performing half-wave rectification on the voltage signal Vac. The detection signals Dtp1, Dtp2, and Dtp3 input to the heater driving unit 80 are input to the control circuit 83. A state signal Dt indicating a driving state of the drive circuit 82 is input to the control circuit 83. The control circuit 83 generates a drive control signal Dr corresponding to the input detection signals Dtp1, Dtp2, and Dtp3 and the input state signal Dt and outputs the drive control signal Dr to the drive circuit 82. The drive circuit 82 generates the drive signals HC1, HC2, and HC3 as the drive signals HC in accordance with the voltage signal Vre input from the rectifier circuit 81 and the drive control signal Dr input from the control circuit 83, and outputs the drive signals HC1, HC2, and HC3 from the heater driving unit 80.

In the heater driving unit 80 configured as described above, the drive circuit 82 generates the drive signal HC1 for controlling the temperature of the heater 90a, based on the detection signal Dtp1 corresponding to the temperature of the heater 90a, generates the drive signal HC2 for controlling the temperature of the heater 90b, based on the detection signal Dtp2 corresponding to the temperature of the heater 90b, and generates the drive signal HC3 for controlling the temperature of the heater 90c, based on the detection signal Dtp3 corresponding to the temperature of the heater 90c. Therefore, the temperature of each of the heaters 90a, 90b, and 90c can be individually controlled to a desired temperature. Details of the configuration and operation of the heater driving unit 80 will be described later.

As described above, the liquid ejecting apparatus 1 according to the present embodiment includes the transport unit 40 that transports the medium P, the print heads 22 that eject ink, which is an example of liquid, onto the medium P, the heaters 90a, 90b, and 90c that heat the medium P, the detection circuits 95a, 95b, and 95c that detect the temperatures of the heaters 90a, 90b, and 90c, and the heater driving unit 80 that outputs the drive signals HC1, HC2, and HC3 to the heaters 90a, 90b, and 90c in accordance with the detection signals Dtp1, Dtp2, and Dtp3 corresponding to the results of the detection by the detection circuits 95a, 95b, and 95c.

### 3. CONFIGURATION AND OPERATION OF HEATER DRIVING UNIT

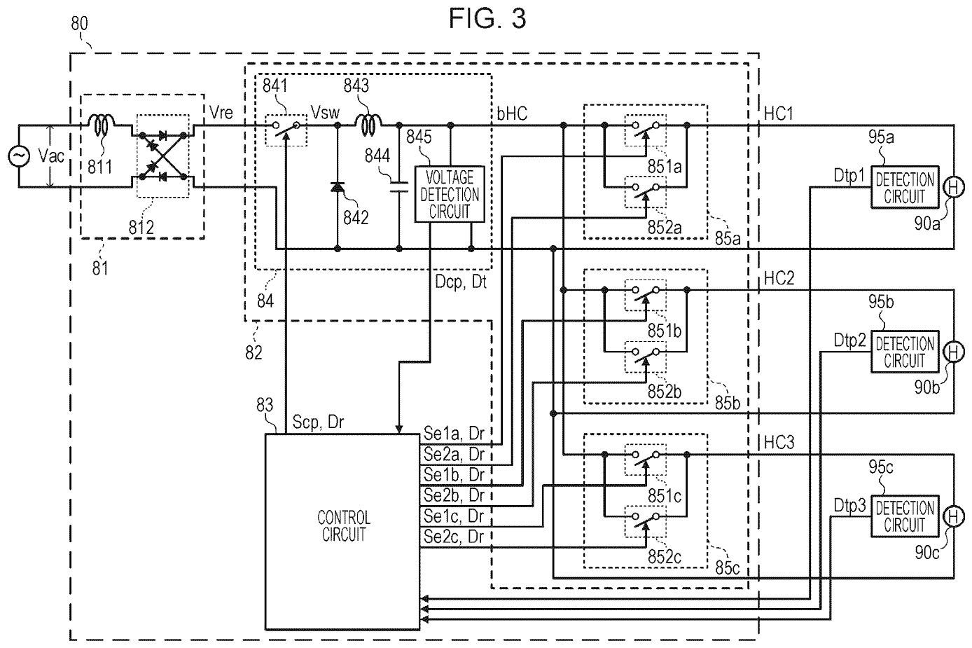

FIG. 3 is a diagram illustrating a configuration of the heater driving unit 80. As described above, the heater driving unit 80 includes the rectifier circuit 81, the drive circuit 82, and the control circuit 83. FIG. 3 illustrates, in addition to the configuration of the heater driving unit 80, the heaters 90a to 90c to which the drive signals HC1 to HC3 output by the heater driving unit 80 are supplied, and the detection circuits 95a to 95c that output the detection signals Dtp1 to Dtp3 corresponding to the temperatures of the heaters 90a to 90c.

The rectifier circuit 81 includes an inductor 811 and a diode bridge 812. The voltage signal Vac supplied to the liquid ejecting apparatus 1 is supplied to one end of the inductor 811 and one input terminal of the diode bridge 812. The other end of the inductor 811 is electrically coupled to the other input terminal of the diode bridge 812. The diode bridge 812 generates the voltage signal Vre by performing the full-wave rectification on the input voltage signal Vac, and outputs the voltage signal Vre from a positive-side output terminal. In this case, an electrical potential of a negative-side output terminal of the diode bridge 812 is a reference electrical potential serving as a reference for the operation of the heater driving unit 80.

The inductor 811 included in the rectifier circuit 81 functions as a normal filter that reduces normal mode noise superimposed on the voltage signal Vac. This improves the accuracy of the waveform of the voltage signal Vre output by the rectifier circuit 81. The rectifier circuit 81 may include an inductor element such as a line filter that reduces the common mode noise superimposed on the voltage signal Vac, instead of the inductor 811 or in addition to the inductor 811.

The drive circuit 82 includes a switching circuit 84 and switch circuits 85a, 85b, and 85c. The switching circuit 84 includes a switch element 841, a diode 842, an inductor 843, a capacitor 844, and a voltage detection circuit 845.

The switch element 841 includes, for example, an n-channel FET element. The voltage signal Vre is input to a drain terminal of the switch element 841 that is a first terminal of the switch element 841. A control signal Scp as a drive control signal Dr output by the control circuit 83 is input to a gate terminal of the switch element 841 that is a control terminal of the switch element 841. A source terminal of the switch element 841 that is a second terminal of the switch element 841 is electrically coupled to a cathode terminal of the diode 842 and one end of the inductor 843. The other end of the inductor 843 is electrically coupled to one end of the capacitor 844. The reference electrical potential for the heater driving unit 80 is supplied to an anode terminal of the diode 842 and the other end of the capacitor 844. Then, the switching circuit 84 outputs, as a base drive signal bHC, a voltage value of a node where the other end of the inductor 843 and the one end of the capacitor 844 are electrically coupled to each other.

In addition, one end of the voltage detection circuit 845 is electrically coupled to the node where the other end of the inductor 843 and the one end of the capacitor 844 are electrically coupled to each other and through which the base drive signal bHC is propagated. The reference electrical potential for the heater driving unit 80 is supplied to the other end of the voltage detection circuit 845. The voltage detection circuit 845 detects the voltage value of the base drive signal bHC based on a difference in electrical potential between the base drive signal bHC propagating through the node to which the one end of the voltage detection circuit 845 is coupled and the reference electrical potential for the heater driving unit 80 supplied to the other end of the voltage detection circuit 845. The voltage detection circuit 845 generates a detection signal Dcp corresponding to the result of the detection. Specifically, the voltage detection circuit 845 includes a peak hold circuit in which a voltage held in each period of the voltage signal Vre is reset, and acquires the maximum voltage value of the base drive signal bHC in each period of the voltage signal Vre. The maximum value of the base drive signal bHC in each period of the voltage signal Vre is the voltage held in the peak hold circuit in each period of the voltage signal Vre. Then, the voltage detection circuit 845 generates the detection signal Dcp corresponding to the acquired value, and outputs, as a state signal Dt, the generated detection signal Dcp to the control circuit 83. The configuration of the voltage detection circuit 845 is not limited to the configuration including the peak hold circuit, and the voltage detection circuit 845 may be configured to acquire an average value or an effective value of the voltage value of the base drive signal bHC in each period of the voltage signal Vre.

Further, the diode 842 included in the switching circuit 84 functions as a regeneration diode that regenerates a current when a signal based on the base drive signal bHC is supplied to the heaters 90a, 90b, and 90c, and that regenerates a current that flows through the capacitor 844. Therefore, the stability of the operation of the switching circuit 84 is improved.

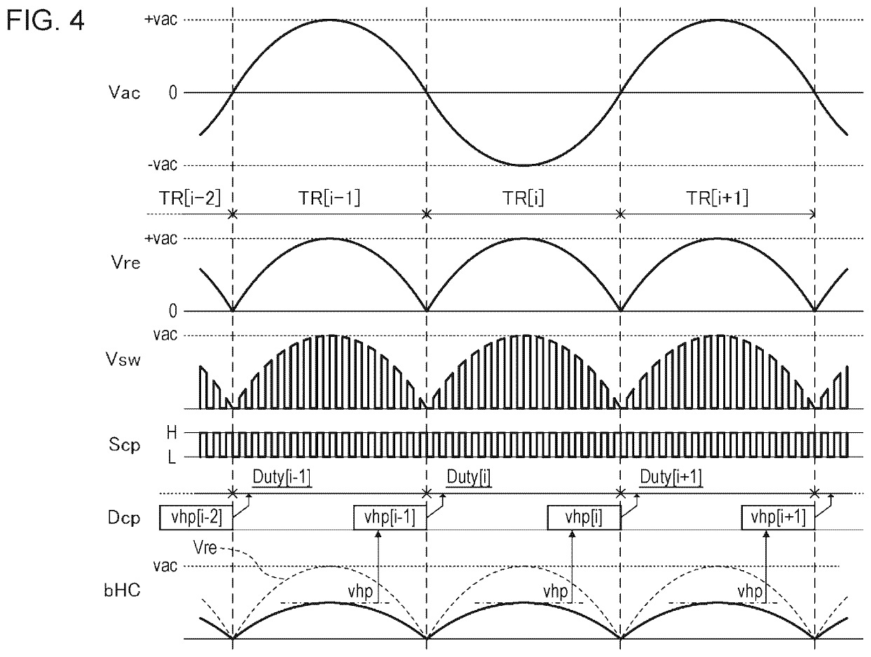

The operation of the switching circuit 84 will be described. FIG. 4 is a diagram illustrating an example of the operation of the switching circuit 84. FIG. 4 illustrates a full-wave period TR[i] (i is any natural number) as any period, a full-wave period TR[i−1] immediately before the full-wave period TR[i], and a full-wave period TR[i+1] immediately after the full-wave period TR[i] as full-wave periods TR that are periods of the voltage signal Vre input to the switching circuit 84. For example, the full-wave period TR is a period that repeats approximately every 10 ms in a case where the voltage signal Vac is at a frequency of 50 Hz, and is a period that repeats approximately every 8.3 ms in a case where the voltage signal Vac is at a frequency of 60 Hz. In the following description, it is assumed that the first terminal and the second terminal of the switch element 841 are controlled to be conductive when an H-level control signal Scp is input to the control terminal of the switch element 841, and that the first terminal and the second terminal of the switch element 841 are controlled to be non-conductive when an L-level control signal Scp is input to the control terminal of the switch element 841. The relationship between the conduction state of the switch element 841 and the logic level of the control signal Scp is not limited to the above-described relationship.

As illustrated in FIG. 4, the rectifier circuit 81 generates the voltage signal Vre whose voltage value changes between +vac [V] and the reference electrical potential for the heater driving unit 80 by performing the full-wave rectification on the voltage signal Vac that is an alternating current voltage signal and whose voltage value changes between +vac [V] and −vac [V]. The voltage signal Vre generated by the rectifier circuit 81 is input to the first terminal of the switch element 841 of the switching circuit 84.

The switch element 841 switches whether to output, from the second terminal, the voltage signal Vre supplied to the first terminal as a voltage signal Vsw in accordance with the logic level of the control signal Scp input to the control terminal. In this case, the frequency of the control signal Scp input to the control terminal of the switch element 841 is sufficiently higher than the frequency of the voltage signal Vre and is set to a frequency of several kHz or higher. That is, the switch element 841 is driven at a switching frequency of several kHz or higher. Therefore, at the second terminal of the switch element 841, the voltage signal Vsw having a signal waveform in which the voltage signal Vre is shaped into a comb shape in accordance with the frequency of the control signal Scp as illustrated in FIG. 4 is generated. In other words, the switch element 841 outputs, from the second terminal, the voltage signal Vsw obtained by shaping the voltage signal Vre into the comb shape in accordance with the frequency of the control signal Scp.

The voltage signal Vsw is supplied to the one end of the inductor 843. As described above, the other end of the inductor 843 is electrically coupled to the one end of the capacitor 844, and the reference electrical potential for the heater driving unit 80 is supplied to the other end of the capacitor 844. That is, the inductor 843 and the capacitor 844 constitute a low-pass filter circuit. The voltage signal Vsw output by the switch element 841 is smoothed by the low-pass filter circuit including the inductor 843 and the capacitor 844. In this case, the cutoff frequency of the low-pass filter circuit is set to a value that is sufficiently greater than the frequency of the voltage signal Vre and is less than the frequency of the control signal Scp. Specifically, in a case where the frequency of the control signal Scp is 20 kHz, the cutoff frequency of the low-pass filter circuit including the inductor 843 and the capacitor 844 is set to a frequency of approximately 10 kHz. In a case where the frequency of the control signal Scp is 50 kHz, the cutoff frequency of the low-pass filter circuit including the inductor 843 and the capacitor 844 is set to a frequency of approximately 30 KHz to 40 kHz. Therefore, a signal obtained by smoothing the voltage signal Vsw having the comb shape, that is, by changing the voltage amplitude of the voltage signal Vre is generated at the node that is an output of the low-pass filter circuit constituted by the inductor 843 and the capacitor 844 and where the other end of the inductor 843 and the one end of the capacitor 844 are electrically coupled to each other. That is, the switching circuit 84 outputs, as the base drive signal bHC, the signal obtained by changing the voltage amplitude of the voltage signal Vre.

In this case, the voltage detection circuit 845 acquires the maximum voltage value of the base drive signal bHC in each full-wave period TR, generates a detection signal Dcp corresponding to the acquired maximum voltage value of the base drive signal bHC, and outputs the detection signal Dcp to the control circuit 83. The control circuit 83 controls, in accordance with the input detection signal Dcp, the on-duty of the control signal Scp to be output. Specifically, the control circuit 83 acquires, as a voltage vhp[i−1], the maximum voltage value vhp of the base drive signal bHC in the full-wave period TR[i−1] based on the detection signal Dcp input in the full-wave period TR[i−1]. In a case where the voltage value of the acquired voltage vhp[i−1] is greater than a target voltage value, the control circuit 83 sets the on-duty of the control signal Scp to be output in the full-wave period TR[i] to be less than the on-duty of the control signal Scp output in the full-wave period TR[i−1]. As a result, the maximum voltage value of the base drive signal bHC in the full-wave period TR[i] becomes less than the maximum voltage value of the base drive signal bHC in the full-wave period TR[i−1]. On the other hand, in a case where the voltage value of the acquired voltage vhp[i−1] is less than the target voltage value, the control circuit 83 sets the on-duty of the control signal Scp to be output in the full-wave period TR[i] to be greater than the on-duty of the control signal Scp output in the full-wave period TR[i−1]. As a result, the maximum voltage value of the base drive signal bHC in the full-wave period TR[i] becomes greater than the maximum voltage value of the base drive signal bHC in the full-wave period TR[i−1].

That is, the control circuit 83 controls, in accordance with the input detection signal Dcp, the on-duty of the control signal Scp to be output, and thus the switching circuit 84 outputs the base drive signal bHC controlled such that the maximum voltage value is substantially constant at the target voltage value regardless of the voltage amplitude of the voltage signal Vac supplied to the liquid ejecting apparatus 1 and the voltage amplitude of the voltage signal Vre output by the rectifier circuit 81. The control circuit 83 may determine the on-duty of the control signal Scp to be output, by PID control based on a result of comparison between the maximum voltage value of the base drive signal bHC acquired based on the detection signal Dcp in each full-wave period TR and the target voltage value.

Returning to FIG. 3, the base drive signal bHC output by the switching circuit 84 is input to the switch circuits 85a, 85b, and 85c.

The switch circuit 85a includes switch elements 851a and 852a. The base drive signal bHC is supplied to a first terminal of the switch element 851a and a first terminal of the switch element 852a. A second terminal of the switch element 851a is electrically coupled to a second terminal of the switch element 852a. A control signal Se1a as a drive control signal Dr output by the control circuit 83 is input to a control terminal of the switch element 851a. A control signal Se2a as a drive control signal Dr output by the control circuit 83 is input to a control terminal of the switch element 852a. Then, the switch circuit 85a outputs, to the heater 90a as the drive signal HC1, a voltage value of a node where the second terminal of the switch element 851a and the second terminal of the switch element 852a are electrically coupled to each other. As each of the switch elements 851a and 852a, for example, a triac element, an FET, an IGBT element, or the like can be used.

In the switch circuit 85a configured as described above, the conduction states of the switch elements 851a and 852a are controlled based on the control signals Se1a and Se2a output by the control circuit 83, respectively. Thus, the switch circuit 85a switches whether to output the base drive signal bHC as the drive signal HC1. That is, at least one of the amounts of voltage and current that are to be supplied to the heater 90a by the drive signal HC1 is controlled based on the control signals Se1a and Se2a output by the control circuit 83. In other words, the amount of heat to be generated by the heater 90a, that is, the temperature of the heater 90a is controlled by the control signals Se1a and Se2a output by the control circuit 83.

In the following description, it is assumed that the first terminal and the second terminal of each of the switch elements 851a and 852a are controlled to be conductive when H-level control signals Se1a and Se2a are input to the control terminals of the switch elements 851a and 852a, respectively, and that the first terminal and the second terminal of each of the switch elements 851a and 852a are controlled to be non-conductive when L-level control signals Se1a and Se2a are input to the control terminals of the switch elements 851a and 852a, respectively. The relationship between the conduction state between the first terminal and the second terminal of each of the switch elements 851a and 852a and the logic levels of the control signals Se1a and Se2a is not limited thereto.

The switch circuit 85b includes switch elements 851b and 852b. The base drive signal bHC is supplied to a first terminal of the switch element 851b and a first terminal of the switch element 852b. A second terminal of the switch element 851b is electrically coupled to a second terminal of the switch element 852b. A control signal Se1b as a drive control signal Dr output by the control circuit 83 is input to a control terminal of the switch element 851b. A control signal Se2b as a drive control signal Dr output by the control circuit 83 is input to a control terminal of the switch element 852b. Then, the switch circuit 85b outputs, to the heater 90b as the drive signal HC2, a voltage value of a node where the second terminal of the switch element 851b and the second terminal of the switch element 852b are electrically coupled to each other. As each of the switch elements 851b and 852b, for example, a triac element, an FET, an IGBT element, or the like can be used.

In the switch circuit 85b configured as described above, the conduction states of the switch elements 851b and 852b are controlled based on the control signals Se1b and Se2b output by the control circuit 83, respectively. Thus, the switch circuit 85b switches whether to output the base drive signal bHC as the drive signal HC2. That is, at least one of the amounts of voltage and current that are to be supplied to the heater 90b by the drive signal HC2 is controlled based on the control signals Se1b and Se2b output by the control circuit 83. In other words, the amount of heat to be generated by the heater 90b, that is, the temperature of the heater 90b is controlled by the control signals Se1b and Se2b output by the control circuit 83.

In the following description, it is assumed that the first terminal and the second terminal of each of the switch elements 851b and 852b are controlled to be conductive when H-level control signals Se1b and Se2b are input to the control terminals of the switch elements 851b and 852b, respectively, and that the first terminal and the second terminal of each of the switch elements 851b and 852b are controlled to be non-conductive when L-level control signals Se1b and Se2b are input to the control terminals of the switch elements 851b and 852b, respectively. The relationship between the conduction state between the first terminal and the second terminal of each of the switch elements 851b and 852b and the logic levels of the control signals Se1b and Se2b is not limited thereto.

The switch circuit 85c includes switch elements 851c and 852c. The base drive signal bHC is supplied to a first terminal of the switch element 851c and a first terminal of the switch element 852c. A second terminal of the switch element 851c is electrically coupled to a second terminal of the switch element 852c. A control signal Se1c as a drive control signal Dr output by the control circuit 83 is input to a control terminal of the switch element 851c. A control signal Se2c as a drive control signal Dr output by the control circuit 83 is input to a control terminal of the switch element 852c. Then, the switch circuit 85c outputs, to the heater 90c as the drive signal HC3, a voltage value of a node where the second terminal of the switch element 851c and the second terminal of the switch element 852c are electrically coupled to each other. As each of the switch elements 851c and 852c, for example, a triac element, an FET, an IGBT element, or the like can be used.

In the switch circuit 85c configured as described above, the conduction states of the switch elements 851c and 852c are controlled based on the control signals Se1c and Se2c output by the control circuit 83, respectively. Thus, the switch circuit 85c switches whether to output the base drive signal bHC as the drive signal HC3. That is, at least one of the amounts of voltage and current that are to be supplied to the heater 90c by the drive signal HC3 is controlled based on the control signals Se1c and Se2c output by the control circuit 83. In other words, the amount of heat to be generated by the heater 90c, that is, the temperature of the heater 90c is controlled by the control signals Se1c and Se2c output by the control circuit 83.

In the following description, it is assumed that the first terminal and the second terminal of each of the switch elements 851c and 852c are controlled to be conductive when H-level control signals Se1c and Se2c are input to the control terminals of the switch elements 851c and 852c, respectively, and that the first terminal and the second terminal of each of the switch elements 851c and 852c are controlled to be non-conductive when L-level control signals Se1c and Se2c are input to the control terminals of the switch elements 851c and 852c, respectively. The relationship between the conduction state between the first terminal and the second terminal of each of the switch elements 851c and 852c and the logic levels of the control signals Se1c and Se2c is not limited thereto.

As described above, the control circuit 83 controls the temperature of the heater 90a by controlling the on-duties of the control signals Se1a and Se2a in each of temperature control periods TM that are predetermined periods of time, controls the temperature of the heater 90b by controlling the on-duties of the control signals Se1b and Se2b in each of the temperature control periods TM that are the predetermined periods of time, and controls the temperature of the heater 90c by controlling the on-duties of the control signals Se1c and Se2c in each of the temperature control periods TM that are the predetermined periods of time. The plurality of temperature control periods TM in which the control circuit 83 controls the temperatures of the heaters 90a, 90b, and 90c are all periods of the same time length, and are set to be sufficiently longer than the full-wave period TR that is the period of the voltage signal Vre, and are, for example, longer than or equal to 1 second, and are preferably approximately 1.5 seconds. In other words, each of the plurality of temperature control periods TM is a period of time longer than or equal to 1 second.

As described above, the heater driving unit 80 includes: the switch circuit 85a that switches whether to supply the base drive signal bHC to the heater 90a and includes the switch element 851a that switches whether to supply the base drive signal bHC to the heater 90a, and the switch element 852a that switches whether to supply the base drive signal bHC to the heater 90a; the switch circuit 85b that switches whether to supply the base drive signal bHC to the heater 90b and includes the switch element 851b that switches whether to supply the base drive signal bHC to the heater 90b, and the switch element 852b that switches whether to supply the base drive signal bHC to the heater 90b; the switch circuit 85c that switches whether to supply the base drive signal bHC to the heater 90c and includes the switch element 851c that switches whether to supply the base drive signal bHC to the heater 90c, and the switch element 852c that switches whether to supply the base drive signal bHC to the heater 90c; and the control circuit 83 that controls the switch elements 851a and 852a included in the switch circuit 85a, the switch elements 851b and 852b included in the switch circuit 85b, and the switch elements 851c and 852c included in the switch circuit 85c in each of the plurality of temperature control periods TM. As a result, the heater driving unit 80 supplies the base drive signal bHC to the heaters 90a to 90c.

A specific example of the control of the temperatures of the heaters 90a, 90b, and 90c will be described. The switch circuits 85a, 85b, and 85c that switch whether to supply the base drive signal bHC as the drive signals HC1, HC2, and HC3 to each of the heaters 90a, 90b, and 90c have the same configuration except that the signals input to the switch circuits 85a, 85b, and 85c are different and that the signals output by the switch circuits 85a, 85b, and 85c are different. Therefore, in the following description, in a case where it is not necessary to distinguish the switch circuits 85a, 85b, and 85c, the switch circuits 85a, 85b, and 85c may be simply referred to as a switch circuit 85. In the following description, it is assumed that the switch circuit 85 includes a switch element 851 as the switch elements 851a, 851b, and 851c and a switch element 852 as the switch elements 852a, 852b, and 852c, and supplies a drive signal HC as the drive signals HC1, HC2, and HC3 to a heater 90 as the heaters 90a, 90b, and 90c. In this case, in the following description, it is assumed that the control circuit 83 outputs a control signal Se1 as the control signals Se1a, Se1b, and Se1c to the control terminal of the switch element 851 and outputs a control signal Se2 as the control signals Se2a, Se2b, and Se2c to the control terminal of the switch element 852, and that a detection signal Dtp as the detection signals Dtp1, Dtp2, and Dtp3 corresponding to the temperature of the heater 90 detected by a detection circuit 95 as the detection circuits 95a, 95b, and 95c is input to the control circuit 83. In the following description, the base drive signal bHC propagating through the switch element 851 may be referred to as a base drive signal bHC1, and the base drive signal bHC propagating through the switch element 852 may be referred to as a base drive signal bHC2.

The control circuit 83 according to the present embodiment controls at least one of the amounts of voltage and current that are to be supplied to the heater 90 as the drive signal HC by controlling the on-duties of the control signals Se1 and Se2 to be output in each temperature control period TM. That is, the temperature of the heater 90 is controlled by the control circuit 83 in each temperature control period TM.

Specifically, the control circuit 83 controls the logic levels of the control signals Se1 and Se2 to be output in each of a first half period TFH from when a temperature control period TM starts to when a predetermined period of time elapses after the start of the temperature control period TM and a second half period TSH from when the first half period TFH ends to when the temperature control period TM ends. In this case, the control circuit 83 controls the ratio of the length of the first half period TFH to the length of the temperature control period TM and the ratio of the length of the second half period TSH to the length of the temperature control period TM by controlling at least one of the length of the first half period TFH and the length of the second half period TSH based on the temperature of the heater 90, and controls the on-duties of the control signals Se1 and Se2 in the temperature control period TM. Accordingly, at least one of the amounts of voltage and current that are to be supplied to the heater 90 in the temperature control period TM is controlled, and the temperature of the heater 90 in the temperature control period TM is controlled.

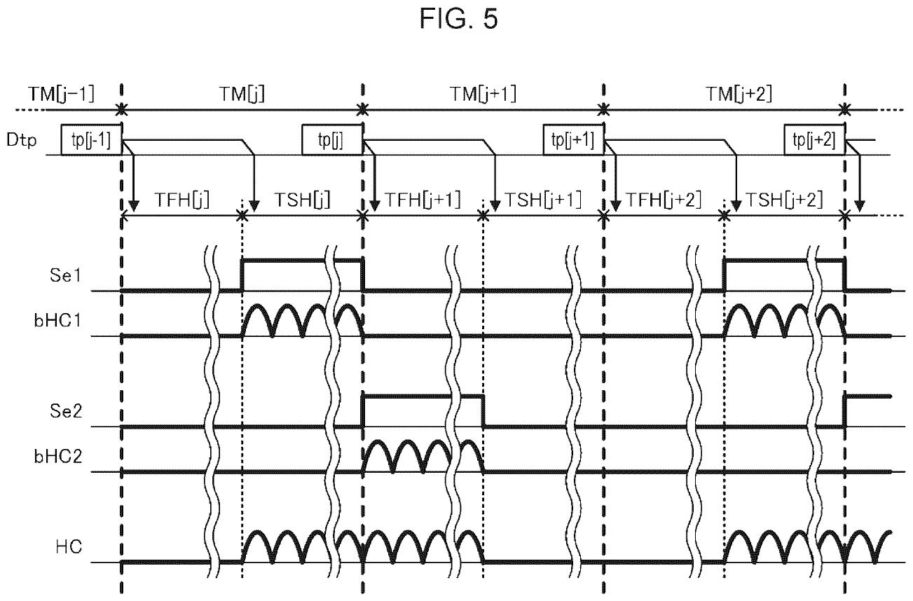

FIG. 5 is a diagram illustrating an example of a method of controlling the temperature of the heater 90. FIG. 5 illustrates any temperature control period TM[j] (j is any natural number), a temperature control period TM[j+1] continuous to the temperature control period TM[j], and a temperature control period TM[j+2] continuous to the temperature control period TM[j+1] as temperature control periods TM that are periods for controlling the temperature of the heater 90.

In a first half period TFH[j] of the temperature control period TM[j], the control circuit 83 outputs an L-level control signal Se1 and an L-level control signal Se2. Therefore, in the first half period TFH[j], the switch element 851 and the switch element 852 are controlled to be non-conductive. In this case, the switch circuit 85 does not output the base drive signal bHC as the drive signal HC. Further, in a second half period TSH[j] continuous to the first half period TFH[j] in the temperature control period TM[j], the control circuit 83 outputs an H-level control signal Se1 and the L-level control signal Se2. Therefore, in the second half period TSH[j], the switch element 851 is controlled to be conductive and the switch element 852 is controlled to be non-conductive. In this case, the switch circuit 85 outputs, to the heater 90 as the drive signal HC, the base drive signal bHC1 propagating through the switch element 851. As described above, the amount of each of voltage and current that are to be supplied to the heater 90 in the temperature control period TM[j], that is, the temperature of the heater 90 in the temperature control period TM[j] is defined based on the on-duty of the control signal Se1 in the temperature control period TM[j], that is, the ratio of the length of the second half period TSH[j] to the length of the temperature control period TM[j].

In the temperature control period TM[j−1] continuous to the temperature control period TM[j] and immediately preceding the temperature control period TM[j], the control circuit 83 controls the ratio of the length of the second half period TSH[j] to the length of the temperature control period TM[j], that is, the on-duty of the control signal Se1 in the temperature control period TM[j] based on the detection signal Dtp input from the detection circuit 95. Specifically, the control circuit 83 acquires temperature information tp[j−1] corresponding to the temperature of the heater 90 in the temperature control period TM[j−1] based on the detection signal Dtp input in the temperature control period TM[j−1]. In a case where the temperature of the heater 90 indicated in the acquired temperature information tp[j−1] is higher than a target temperature, the control circuit 83 controls the length of the second half period TSH[j] such that the on-duty of the control signal Se1 output in the temperature control period TM[j] is less than the on-duty of the control signal Se2 output in the temperature control period TM[j−1]. Accordingly, the amounts of the voltage and the current supplied to the heater 90 in the temperature control period TM[j] decrease and become less than the amounts of voltage and current supplied to the heater 90 in the temperature control period TM[j−1]. Therefore, the temperature of the heater 90 in the temperature control period TM[j] decreases toward the target temperature.

On the other hand, in a case where the temperature of the heater 90 indicated in the acquired temperature information tp[j−1] is lower than the target temperature, the control circuit 83 controls the length of the second half period TSH[j] such that the on-duty of the control signal Se1 output in the temperature control period TM[j] is greater than the on-duty of the control signal Se2 output in the temperature control period TM[j−1]. As a result, the amounts of the voltage and the current supplied to the heater 90 in the temperature control period TM[j] increase and become greater than the amounts of the voltage and current supplied to the heater 90 in the temperature control period TM[j−1]. Therefore, the temperature of the heater 90 in the temperature control period TM[j] rises toward the target temperature.

That is, in the temperature control period TM[j], the control circuit 83 controls the switch elements 851 and 852 such that the switch element 851 switches from a state in which the base drive signal bHC is not supplied to the heater 90 to a state in which the base drive signal bHC is supplied to the heater 90 and that the switch element 852 maintains a state in which the base drive signal bHC is not supplied to the heater 90. In other words, in the temperature control period TM[j], the control circuit 83 switches the switch circuit 85 from a state in which the base drive signal bHC is not supplied to the heater 90 to a state in which the base drive signal bHC is supplied to the heater 90. In this case, the control circuit 83 controls, in accordance with the acquired temperature information tp[j−1], the ratio of the length of the period of time when the switch circuit 85 supplies the base drive signal bHC to the heater 90 to the length of the temperature control period TM[j], that is, the ratio of the length of the second half period TSH[j] to the length of the temperature control period TM[j]. Accordingly, the amounts of the voltage and the current that are to be supplied to the heater 90 in the temperature control period TM[j] are controlled.

In the first half period TFH[j+1] of the temperature control period TM[j+1] continuous to the temperature control period TM[j], the control circuit 83 outputs the L-level control signal Se1 and an H-level control signal Se2. Therefore, in the first half period TFH[j+1], the switch element 851 is controlled to be non-conductive and the switch element 852 is controlled to be conductive. In this case, the switch circuit 85 outputs, to the heater 90 as the drive signal HC, the base drive signal bHC2 propagating through the switch element 852. Further, in the second half period TSH[j+1] continuous to the first half period TFH[j+1] in the temperature control period TM[j+1], the control circuit 83 outputs the L-level control signal Se1 and the L-level control signal Se2. Therefore, in the second half period TSH[j+1], the switch element 851 and the switch element 852 are controlled to be non-conductive. In this case, the switch circuit 85 does not output the base drive signal bHC as the drive signal HC. Thus, the amount of each of voltage and current that are to be supplied to the heater 90 in the temperature control period TM[j+1], that is, the temperature of the heater 90 in the temperature control period TM[j+1], is defined based on the on-duty of the control signal Se2 in the temperature control period TM[j+1], that is, the ratio of the length of the first half period TFH[j+1] to the length of the temperature control period TM[j+1].

In the temperature control period TM[j], the control circuit 83 controls, based on the detection signal Dtp input from the detection circuit 95, the on-duty of the control signal Se2 in the temperature control period TM[j+1], that is, the ratio of the length of the first half period TFH[j+1] to the length of the temperature control period TM[j+1]. Specifically, the control circuit 83 acquires the temperature information tp[j] corresponding to the temperature of the heater 90 in the temperature control period TM[j] based on the detection signal Dtp input in the temperature control period TM[j]. In a case where the temperature of the heater 90 indicated in the acquired temperature information tp[j] is higher than the target temperature, the control circuit 83 controls the length of the first half period TFH[j+1] such that the on-duty of the control signal Se2 output in the temperature control period TM[j+1] is less than the on-duty of the control signal Se1 output in the temperature control period TM[j]. As a result, the amounts of the voltage and the current supplied to the heater 90 in the temperature control period TM[j+1] decrease and become less than the amounts of the voltage and current supplied to the heater 90 in the temperature control period TM[j]. Therefore, the temperature of the heater 90 in the temperature control period TM[j+1] decreases toward the target temperature.

On the other hand, in a case where the temperature of the heater 90 indicated in the acquired temperature information tp[j] is lower than the target temperature, the control circuit 83 controls the length of the first half period TFH[j+1] such that the on-duty of the control signal Se2 output in the temperature control period TM[j+1] is greater than the on-duty of the control signal Se1 output in the temperature control period TM[j]. As a result, the amounts of the voltage and the current supplied to the heater 90 in the temperature control period TM[j+1] increase and become greater than the amounts of the voltage and current supplied to the heater 90 in the temperature control period TM[j]. Therefore, the temperature of the heater 90 in the temperature control period TM[j+1] rises toward the target temperature.

That is, in the temperature control period TM[j+1] continuous to the temperature control period TM[j], the control circuit 83 controls the switch elements 851 and 852 such that the switch element 851 maintains the state in which the base drive signal bHC is not supplied to the heater 90 and that the switch element 852 switches from a state in which the base drive signal bHC is supplied to the heater 90 to the state in which the base drive signal bHC is not supplied to the heater 90. In other words, in the temperature control period TM[j+1] continuous to the temperature control period TM[j], the control circuit 83 switches the switch circuit 85 from the state in which the base drive signal bHC is supplied to the heater 90 to the state in which the base drive signal bHC is not supplied to the heater 90. In this case, the control circuit 83 controls, in accordance with the acquired temperature information tp[j], the ratio of the length of the period of time when the switch circuit 85 supplies the base drive signal bHC to the heater 90 to the length of the temperature control period TM[j+1], that is, the ratio of the length of the first half period TFH[j+1] to the length of the temperature control period TM[j+1]. Thus, the amounts of the voltage and the current that are to be supplied to the heater 90 in the temperature control period TM[j+1] are controlled.

Thereafter, the control circuit 83 executes the same control as in the above-described temperature control period TM[j] in the temperature control period TM[j+2] continuous to the temperature control period TM[j+1], and executes the same control as in the above-described temperature control period TM[j+1] in a temperature control period TM[j+3] (not illustrated) continuous to the temperature control period TM[j+2]. That is, the control circuit 83 alternately and repeatedly executes the control in the temperature control period TM[j] and the control in the temperature control period TM[j+1] in the plurality of temperature control periods TM. Accordingly, the temperature of the heater 90 in each of the plurality of temperature control periods TM is controlled to a predetermined temperature.

In the heater driving unit 80 that operates as described above, the electrical potential of the drive signal HC supplied to the heater 90 in the first half period TFH[j] that is in the temperature control period TM[j] and in which the switch circuit 85 does not supply the base drive signal bHC to the heater 90, and the electrical potential of the drive signal HC supplied to the heater 90 in the second half period TSH[j+1] that is in the temperature control period TM[j+1] and in which the switch circuit 85 does not supply the base drive signal bHC to the heater 90 are both substantially equal to the reference electrical potential for the heater driving unit 80, and the signal waveform of the drive signal HC supplied to the heater 90 in the second half period TSH[j] that is in the temperature control period TM[j] and in which the switch circuit 85 supplies the base drive signal bHC to the heater 90, and the signal waveform of the drive signal HC supplied to the heater 90 in the first half period TFH[j+1] that is in the temperature control period TM[j+1] and in which the switch circuit 85 supplies the base drive signal bHC to the heater 90 are both signal waveforms of the base drive signal bHC and are continuous.

As described above, the control circuit 83 controls, in accordance with the input detection signal Dtp, the on-duties of the control signals Se1 and Se2 to be output, and thus the temperature of the heater 90 is controlled toward the target temperature. The control circuit 83 may determine the on-duties of the control signals Se1 and Se2 to be output, by the PID control based on the result of the comparison between the temperature of the heater 90 acquired based on the detection signal Dtp acquired in each temperature control period TM and the target temperature. As a result, the possibility that the temperature of the heater 90 may overshoot or undershoot is reduced, and the accuracy of controlling the temperature of the heater 90 is improved.

As described above, the lengths of the plurality of temperature control periods TM are all set to be equal. Therefore, in the control of the ratio of the length of the first half period TFH to the length of the temperature control period TM or in the control of the ratio of the length of the second half period TSH to the length of the temperature control period TM, the control circuit 83 may control at least one of the length of the first half period TFH and the length of the second half period TSH in the temperature control period TM. In the following description, a case where the control circuit 83 controls the ratio of the length of the first half period TFH to the length of the temperature control period TM and the ratio of the length of the second half period TSH to the length of the temperature control period TM by controlling the length of the first half period TFH in the temperature control period TM will be described as an example. However, the control circuit 83 may control the ratio of the length of the first half period TFH to the length of the temperature control period TM and the ratio of the length of the second half period TSH to the length of the temperature control period TM by controlling the length of the second half period TSH in the temperature control period TM.

The method of controlling the temperature of the heater 90 as described above, that is, the method of controlling the heater 90 that heats the medium P in the liquid ejecting apparatus 1 that ejects ink onto the medium P will be described in detail. In the following description, the length of the temperature control period TM may be referred to as a time tm, the length of the first half period TFH may be referred to as a time tfh, and the length of the second half period TSH may be referred to as a time tsh.

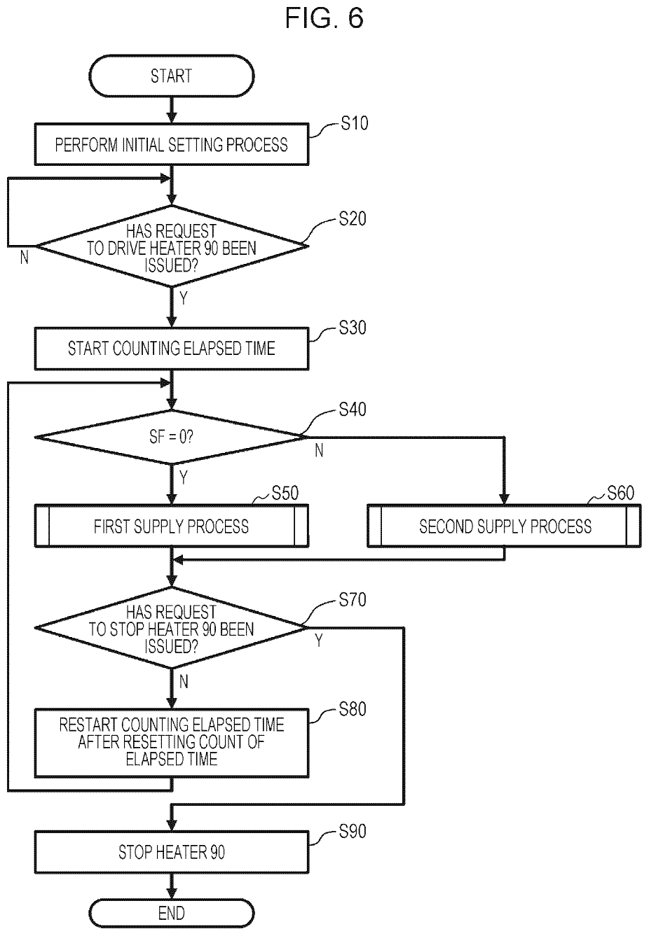

FIG. 6 is a diagram illustrating an example of the method of controlling the heater 90. As illustrated in FIG. 6, in the control of the temperature of the heater 90, the control circuit 83 executes an initial setting process (step S10). The initial setting process that is executed by the control circuit 83 includes, for example, processing of setting a selection flag SF to “0”, processing of setting control duty “duty” to “50” as an initial value, and processing of resetting an elapsed time count value CNT to “0”. Further, the control circuit 83 may execute processing of setting the logic levels of the control signals Se1 and Se2 to an L level as the initial setting process. The initial setting process that is executed by the control circuit 83 is not limited to the above-described process.

After the initial setting process is completed, the control circuit 83 determines whether a request to drive the heater 90 has been issued (step S20). For example, the request to drive the heater 90 may be issued in response to the input of a printing request to the liquid ejecting apparatus 1, may be issued at a timing at which the operation mode of the liquid ejecting apparatus 1 is shifted from a low power consumption operation mode to an operation mode in which an image is printed on the medium P, or may be issued in accordance with a user's operation. If the control circuit 83 determines that the request to drive the heater 90 has not been issued (N in step S20), the control circuit 83 waits for a period of time until the request to drive the heater 90 is issued.

On the other hand, if the control circuit 83 determines that the request to drive the heater 90 has been issued (N in step S20), the control circuit 83 starts counting elapsed time and holds an elapsed time count value CNT corresponding to the counted elapsed time (step S30). The counting of the elapsed time by the control circuit 83 can be executed based on, for example, a clock signal output from an oscillation circuit (not illustrated).

After starting counting the elapsed time, the control circuit 83 determines whether the selection flag SF is “0” (step S40). If the control circuit 83 determines that the selection flag SF is “0” (Y in step S40), the control circuit 83 executes a first supply process (step S50) as a process of controlling the amounts of voltage and current that are to be supplied to the heater 90, that is, as a process of controlling the temperature of the heater 90. If the control circuit 83 determines that the selection flag SF is not “0” (N in step S40), for example, if the selection flag SF is “1”, the control circuit 83 executes a second supply process (step S60) as the process of controlling the amounts of voltage and current that are to be supplied to the heater 90, that is, as the process of controlling the temperature of the heater 90.

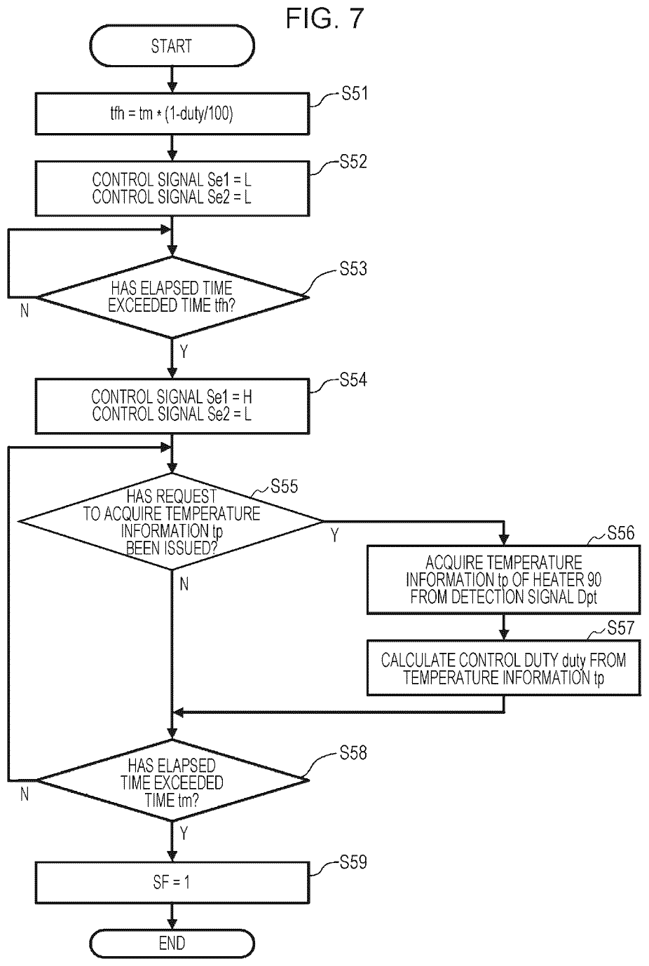

Details of each of the first supply process and the second supply process will be described below. FIG. 7 is a diagram illustrating an example of a method of controlling the heater 90 in the first supply process. As illustrated in FIG. 7, when the first supply process is executed, the control circuit 83 calculates the time tfh that is the length of the first half period TFH by substituting the value of the control duty “duty” and the time tm that is the length of the temperature control period TM into the following Equation (1) (step S51).

$$tf \text{?} = tm \times ( 1 - \frac{duty}{100} ) \qquad ( 1 )$$

$$\text{?} \text{indicates text missing or illegible when filed}$$

Specifically, in a case where the time tm that is the length of the temperature control period TM is 1.5 seconds and the control duty “duty” that is the on-duty of the control signal Se1 or Se2 is 50[%], the control circuit 83 calculates the time tfh to be 0.75 seconds. In a case where the time tm that is the length of the temperature control period TM is 1.5 seconds and the control duty “duty” that is the on-duty of the control signal Se1 or Se2 is 30[%], the control circuit 83 calculates the time tfh to be 1.05 seconds.

Thereafter, the control circuit 83 sets the logic level of the control signal Se1 to be output to an L level, sets the logic level of the control signal Se2 to be output to an L level (step S52), and then compares the elapsed time count value CNT with the calculated time tfh to determine whether the elapsed time has exceeded the time tfh (step S53). If the control circuit 83 determines that the elapsed time based on the elapsed time count value CNT has not exceeded the time tfh (N in step S53), the control circuit 83 waits for a period of time until the elapsed time exceeds the time tfh. That is, the control circuit 83 continues to output the L-level control signal Se1 and the L-level control signal Se2 for a period of time until the elapsed time exceeds the time tfh. This period of time corresponds to at least a period of time within the first half period TFH in the first supply process. Therefore, in the first supply process, the drive circuit 82 does not supply the base drive signal bHC to the heater 90 as the drive signal HC until the elapsed time exceeds the time tfh in the first half period TFH.

Thereafter, if the control circuit 83 determines that the elapsed time based on the elapsed time count value CNT has exceeded the time tfH (Y in step S53), the control circuit 83 sets the logic level of the control signal Se1 to be output to an H level and sets the logic level of the control signal Se2 to be output to an L level (step S54). Accordingly, the drive circuit 82 supplies the base drive signal bHC1 propagating through the switch element 851 included in the switch circuit 85 to the heater 90 as the drive signal HC.

After the supply of the base drive signal bHC1 as the drive signal HC to the heater 90 is started, the control circuit 83 determines whether a request to acquire temperature information tp of the heater 90 has been issued (step S55). If the control circuit 83 determines that the request to acquire the temperature information tp of the heater 90 has been issued (Y in step S55), the detection circuit 95 detects the temperature of the heater 90 and outputs a detection signal Dtp including the temperature information tp corresponding to the detected temperature, and the control circuit 83 acquires the detection signal Dtp output by the detection circuit 95 and acquires the temperature information tp of the heater 90 from the acquired detection signal Dtp (step S56). Thereafter, the control circuit 83 calculates the on-duties of the control signals Se1a and Se2a in the next temperature control period TM from the acquired temperature information tp and the target temperature of the heater 90, and holds the calculated on-duty as the control duty “duty”. That is, the control circuit 83 calculates the control duty “duty” from the temperature information tp (step S57) and holds the control duty “duty”.

The request to acquire the temperature information tp of the heater 90 may be issued at any timing in the second half period TSH of the temperature control period TM, but is preferably issued at a timing immediately before the end of the temperature control period TM. Accordingly, it is possible to more appropriately reflect the temperature of the heater 90 controlled in the temperature control period TM, calculate the on-duties of the control signals Se1a and Se2a in the next temperature control period TM, and improve the accuracy of controlling the temperature of the heater 90. The request to acquire the temperature information tp of the heater 90 may be issued a plurality of times in the second half period TSH of the temperature control period TM. That is, the control circuit 83 may acquire a plurality of pieces of temperature information tp in the second half period TSH of the temperature control period TM. In this case, the control circuit 83 may calculate an average value or a moving average value of the plurality of pieces of acquired temperature information tp and calculate the on-duties of the control signals Se1a and Se2a in the next temperature control period TM using the calculation result as the temperature of the heater 90.

Then, after the control circuit 83 calculates the control duty “duty” from the temperature information tp (step S57), or if the control circuit 83 determines that the request to acquire the temperature information tp of the heater 90 has not been issued (N in step S55), the control circuit 83 compares the elapsed time count value CNT with the time tm to determine whether the elapsed time has exceeded the time tm (step S58). If the control circuit 83 determines that the elapsed time based on the elapsed time count value CNT has not exceeded the time tm (N in step S58), the control circuit 83 determines again whether the request to acquire the temperature information tp of the heater 90 has been issued (step S55). That is, the control circuit 83 waits for a period of time until the elapsed time exceeds the time tm in a state where the above-described steps S55 to S58 are repeatedly executed.

In this case, the control circuit 83 continues to output the H-level control signal Se1 and the L-level control signal Se2. That is, a period of time from when the elapsed time based on the elapsed time count value CNT exceeds the time tfh to when the elapsed time exceeds the time tm corresponds to at least a period of time within the second half period TSH. Therefore, in the first supply process, the drive circuit 82 supplies the base drive signal bHC1 propagating through the switch element 851 to the heater 90 as the drive signal HC in a period of time from when the elapsed time exceeds the time tfh to when the elapsed time exceeds the time tm in the second half period TSH.

Thereafter, if the control circuit 83 determines that the elapsed time based on the elapsed time count value CNT has exceeded the time tm (Y in step S58), the control circuit 83 sets the selection flag SF to “1”, and ends the first supply process.

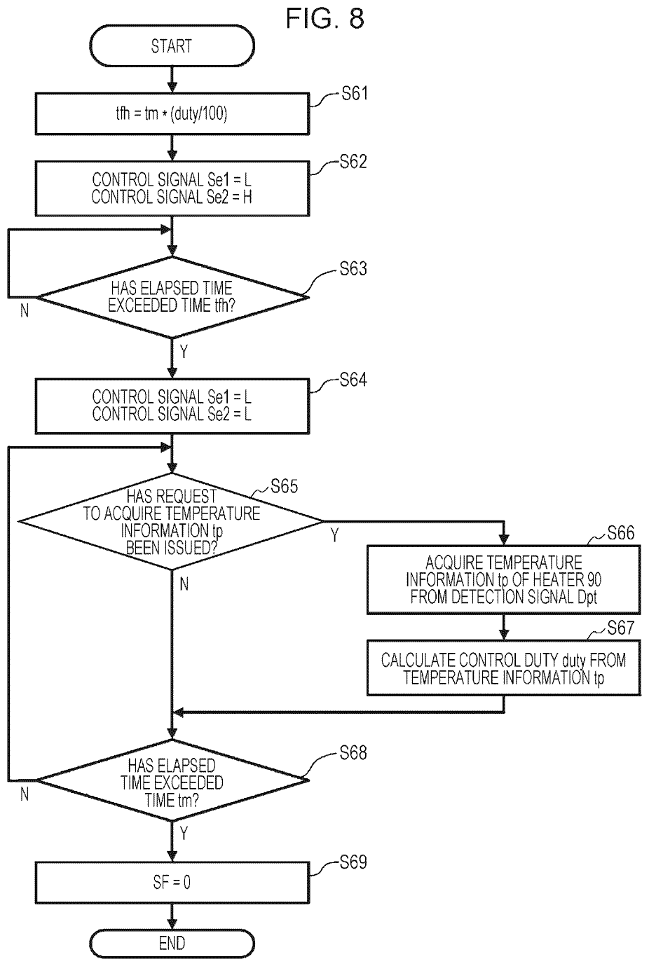

FIG. 8 is a diagram illustrating an example of a method of controlling the heater 90 in the second supply process. As illustrated in FIG. 8, when the second supply process is executed, the control circuit 83 calculates the time tfh that is the length of the first half period TFH by substituting the value of the control duty “duty” and the time tm that is the length of the temperature control period TM into the following Equation (2) (step S61).

$$tf \text{?} = tm \times ( \frac{duty}{100} ) \qquad ( 2 )$$

$$\text{?} \text{indicates text missing or illegible when filed}$$

Specifically, in a case where the time tm that is the length of the temperature control period TM is 1.5 seconds and the control duty “duty” that is the on-duty of the control signal Se1 or the control signal Se2 is 50[%], the control circuit 83 calculates the time tfh to be 0.75 seconds. In a case where the time tm that is the length of the temperature control period TM is 1.5 seconds and the control duty “duty” that is the on-duty of the control signal Se1 or the control signal Se2 is 30 [%], the control circuit 83 calculates the time tfh to be 0.45 seconds.

Thereafter, the control circuit 83 sets the logic level of the control signal Se1 to be output to an L level and sets the logic level of the control signal Se2 to be output to an H level (step S62), and then compares the elapsed time count value CNT with the calculated time tfH to determine whether the elapsed time has exceeded the time tfH (step S63). If the control circuit 83 determines that the elapsed time based on the elapsed time count value CNT has not exceeded the time tfh (N in step S63), the control circuit 83 waits for a period of time until the elapsed time exceeds the time tfh. That is, the control circuit 83 continues to output the L-level control signal Se1 and the H-level control signal Se2 for a period of time until the elapsed time exceeds the time tfH. This period of time corresponds to at least a period of time within the first half period TFH in the second supply process. Therefore, in the second supply process, the drive circuit 82 supplies the base drive signal bHC2 propagating through the switch element 852 to the heater 90 as the drive signal HC until the elapsed time exceeds the time tfh in the first half period TFH.

Thereafter, if the control circuit 83 determines that the elapsed time based on the elapsed time count value CNT has exceeded the time tfh (Y in step S63), the control circuit 83 sets the logic level of the control signal Se1 to be output to an L level, and sets the logic level of the control signal Se2 to be output to an L level (step S64). Accordingly, the drive circuit 82 stops the supply of the base drive signal bHC as the drive signal HC to the heater 90.

After the supply of the base drive signal bHC as the drive signal HC to the heater 90 is stopped, the control circuit 83 determines whether a request to acquire temperature information tp of the heater 90 has been issued (step S65). If the control circuit 83 determines that the request to acquire the temperature information tp of the heater 90 has been issued (Y in step S65), the detection circuit 95 detects the temperature of the heater 90 and outputs a detection signal Dtp including the temperature information tp corresponding to the acquired temperature, and the control circuit 83 acquires the detection signal Dtp output by the detection circuit 95 and acquires the temperature information tp of the heater 90 from the acquired detection signal Dtp (step S66). Thereafter, the control circuit 83 calculates the on-duties of the control signals Se1a and Se2a in the next temperature control period TM from the acquired temperature information tp and the target temperature of the heater 90, and holds the calculated on-duty as the control duty “duty”. That is, the control circuit 83 calculates the control duty “duty” from the temperature information tp (step S67) and holds the control duty “duty”.

The request to acquire the temperature information tp of the heater 90 may be issued at any timing in the second half period TSH of the temperature control period TM, but is preferably issued at a timing immediately before the end of the temperature control period TM. Accordingly, it is possible to more appropriately reflect the temperature of the heater 90 controlled in the temperature control period TM, calculate the on-duties of the control signals Se1a and Se2a in the next temperature control period TM, and improve the accuracy of controlling the temperature of the heater 90. The request to acquire the temperature information tp of the heater 90 may be issued a plurality of times in the second half period TSH of the temperature control period TM. That is, the control circuit 83 may acquire a plurality of pieces of temperature information tp in the second half period TSH of the temperature control period TM. In this case, the control circuit 83 may calculate an average value or a moving average value of the plurality of pieces of acquired temperature information tp and calculate the on-duties of the control signals Se1a and Se2a in the next temperature control period TM using the calculation result as the temperature of the heater 90.

Then, after the control circuit 83 calculates the control duty “duty” from the temperature information tp (step S67), or if the control circuit 83 determines that the request to acquire the temperature information tp of the heater 90 has not been issued (N in step S65), the control circuit 83 compares the elapsed time count value CNT with the time tm to determine whether the elapsed time has exceeded the time tm (step S68). If the control circuit 83 determines that the elapsed time based on the elapsed time count value CNT has not exceeded the time tm (N in step S68), the control circuit 83 determines again whether the request to acquire the temperature information tp of the heater 90 has been issued (step S65). That is, the control circuit 83 waits for a period of time until the elapsed time exceeds the time tm in a state where the above-described steps S65 to S68 are repeatedly executed.

In this case, the control circuit 83 continues to output the L-level control signal Se1 and the L-level control signal Se2. That is, a period of time from when the elapsed time based on the elapsed time count value CNT exceeds the time tfh to when the elapsed time exceeds the time tm corresponds to at least a period of time within the second half period TSH. Therefore, in the second supply process, the drive circuit 82 does not supply the base drive signal bHC to the heater 90 as the drive signal HC in a period of time from when the elapsed time exceeds the time tfh to when the elapsed time exceeds the time tm in the second half period TSH.

Thereafter, if the control circuit 83 determines that the elapsed time based on the elapsed time count value CNT has exceeded the time tm (Y in step S68), the control circuit 83 sets the selection flag SF to “0” and ends the second supply process.

Returning to FIG. 6, when the first supply process (step S50) or the second supply process (step S60) is ended, the control circuit 83 determines whether a request to stop the driven heater 90 has been issued (step S70). If the control circuit 83 determines that the request to stop the heater 90 has not been issued (N in step S70), the control circuit 83 resets the count of the elapsed time based on the elapsed time count value CNT by setting the held elapsed time count value CNT to “0”, and then restarts counting the elapsed time (step S80). Thereafter, the control circuit 83 determines whether the selection flag SF is “0” (step S40), and executes the first supply process (step S50) or the second supply process (step S60) again in accordance with a result of the determination. That is, in a period of time when the heater 90 continues to be driven, the control circuit 83 repeatedly executes the processing in steps S40 to S80. A period of the processing in steps S40 to S80 repeatedly executed by the control circuit 83 corresponds to the temperature control period TM described above.

In a case where the selection flag SF is “0”, the control circuit 83 selects the first supply process (step S50), and the selection flag SF is updated to “1” by executing the first supply process (step S59). Therefore, the control circuit 83 selects the second supply process in step S40 after the first supply process is executed (step S60). In addition, in a case where the selection flag SF is “1”, the control circuit 83 selects the second supply process (step S60), and the selection flag SF is updated to “0” by executing the second supply process (step S69). Therefore, the control circuit 83 selects the first supply process in step S40 after the second supply process is executed (step S50).

That is, in the first supply process, the state in which the base drive signal bHC is not supplied to the heater 90 as the drive signal HC is switched to the state in which the base drive signal bHC is supplied to the heater 90 as the drive signal HC in the temperature control period TM. In the second supply process, the state in which the base drive signal bHC is supplied to the heater 90 as the drive signal HC is switched to the state in which the base drive signal bHC is not supplied to the heater 90 as the drive signal HC in the temperature control period TM. In this case, the first supply process and the second supply process are alternately executed in each temperature control period TM. That is, the second supply process is executed in the next temperature control period TM continuous to the temperature control period TM in which the first supply process is executed.

Thereafter, if the control circuit 83 determines that the request to stop the heater 90 has been issued (Y in step S70), the control circuit 83 stops the supply of the base drive signal bHC as the drive signal HC to the heater 90, and thus the driving of the heater 90 is stopped (step S90). Then, the temperature control of the heater 90 is ended.

The heater 90 that is at least one of the heaters 90a, 90b, and 90c is an example of a heating circuit. The control circuit 83 is an example of a switching control circuit. The heater driving unit 80 is an example of a supply circuit. The switch element 851 is an example of a first switch circuit, and the switch element 852 is an example of a second switch circuit. The detection signal Dtp that is at least one of the detection signals Dtp1, Dtp2, and Dtp3 output by the detection circuits 95a, 95b, and 95c, and the temperature information tp corresponding to the detection signal Dtp are examples of a result of the detection and a result of the detecting. The base drive signal bHC is an example of driving power. The temperature control periods TM are an example of control periods. The temperature control period TM[j] among the plurality of temperature control periods TM is an example of a first control period, and the temperature control period TM[j+1] among the plurality of temperature control periods TM is an example of a second control period. Further, at least one of steps S56 and S66 is an example of detecting. Steps S50 and S60 of supplying the base drive signal bHC corresponding to the result of detecting the temperature in step S56 or step S66 to the heater 90 in each of the plurality of temperature control periods TM are examples of supplying. The first supply process executed in step S50 in the supplying is an example of first supplying, and the second supply process executed in step S60 in the supplying is an example of second supplying.

### 4. OPERATIONS AND EFFECTS

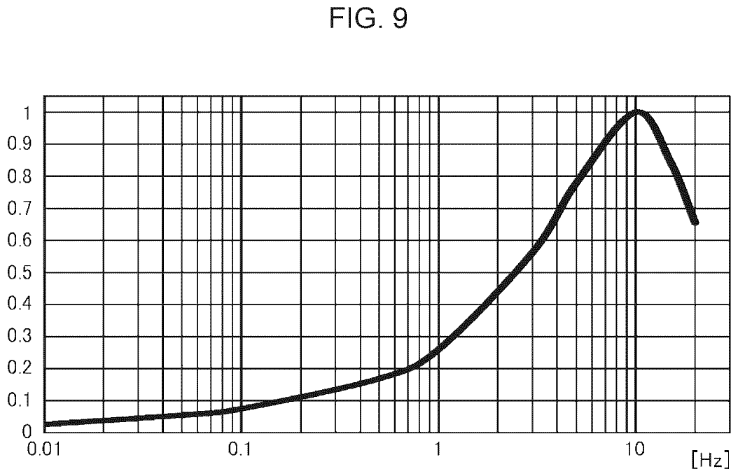

FIG. 9 is a diagram illustrating the relationship between a frequency of a flicker that occurs in a lighting apparatus and visual sensitivity perceived by a person. In FIG. 9, the horizontal axis represents the frequency of the flicker that occurs in the lighting apparatus as a logarithmic axis, and the vertical axis represents a human visual sensitivity coefficient to the flicker as a real number axis. As illustrated in FIG. 9, the sensitivity of a person to the flicker is the highest when the frequency of the flicker is approximately 10 Hz, and decreases as the frequency of the flicker decreases.

In the liquid ejecting apparatus 1 according to the present embodiment, the control circuit 83 switches the switch circuit 85 from the state in which the base drive signal bHC is not supplied to the heater 90 to the state in which the base drive signal bHC is supplied to the heater 90 in the temperature control period TM[j] among the plurality of temperature control periods TM in which the control circuit 83 controls the temperature of the heater 90, and the control circuit 83 switches the switch circuit 85 from the state in which the base drive signal bHC is supplied to the heater 90 to the state in which the base drive signal bHC is not supplied to the heater 90 in the temperature control period TM[j+1] among the plurality of temperature control periods TM. That is, in the two continuous temperature control periods TM that are the temperature control period TM[j] and the temperature control period TM[j+1], the control circuit 83 switches from the state in which the base drive signal bHC is not supplied to the heater 90 to the state in which the base drive signal bHC is supplied to the heater 90, and then switches from the state in which the base drive signal bHC is supplied to the heater 90 to the state in which the base drive signal bHC is not supplied to the heater 90. Therefore, the voltage value of the commercial power supplied to the liquid ejecting apparatus 1 may fluctuate every two continuous temperature control periods TM. Therefore, the period of the voltage fluctuation in the commercial power supplied to the liquid ejecting apparatus 1 when the base drive signal bHC is supplied to the heater 90 that heats the medium P is twice the temperature control period TM in which the temperature of the heater 90 is controlled. Therefore, even if the flicker occurs in the lighting apparatus coupled to a power supply system to which a commercial power supply that supplies the commercial power to the liquid ejecting apparatus 1 is coupled, the period of the flicker is twice the temperature control period TM.

As a result, even if the flicker occurs in the lighting apparatus coupled to the power supply system to which the commercial power supply that supplies the commercial power to the liquid ejecting apparatus 1 is coupled, the sensitivity of a person to the flicker is reduced without a change in the temperature control periods TM for controlling the temperature of the heater 90 in the liquid ejecting apparatus 1 according to the embodiment configured as described above. Therefore, the possibility that a person may feel discomfort due to the flicker is reduced. That is, even if the flicker occurs in the lighting apparatus coupled to the power supply system to which the liquid ejecting apparatus 1 is coupled when the heater 90 is driven, it is possible to reduce the possibility that a person may feel discomfort due to the flicker without a reduction in the accuracy of controlling the temperature of the heater 90 in the liquid ejecting apparatus 1 according to the embodiment is configured as described above.

Similarly, in the method of controlling the heater 90 according to the present embodiment, the first supply process in which the state in which the base drive signal bHC is not supplied to the heater 90 as the drive signal HC is switched to the state in which the base drive signal bHC is supplied to the heater 90 as the drive signal HC in a temperature control period TM, and the second supply process in which the state in which the base drive signal bHC is supplied to the heater 90 as the drive signal HC is switched to the state in which the base drive signal bHC is not supplied to the heater 90 as the drive signal HC in a temperature control period TM are alternately executed in the continuous temperature control periods TM. Accordingly, when the base drive signal bHC is supplied to the heater 90 that heats the medium P, a period of a voltage fluctuation that occurs in the commercial power supplied to the liquid ejecting apparatus 1 is twice the temperature control period TM in which the temperature of the heater 90 is controlled.

As a result, even if the flicker occurs in the lighting apparatus coupled to the power supply system to which the commercial power supply that supplies the commercial power to the liquid ejecting apparatus 1 is coupled, the sensitivity of a person to the flicker is reduced and the possibility that a person may feel discomfort due to the flicker is reduced without a change in the temperature control periods TM for controlling the temperature of the heater 90 in the method of controlling the heater 90 according to the embodiment executed as described above. That is, since the method of controlling the heater 90 according to the embodiment is executed as described above, the possibility that a person may feel discomfort due to a flicker occurring in the lighting apparatus coupled to the power supply system to which the liquid ejecting apparatus 1 is coupled when the heater 90 is driven is reduced without a reduction in the accuracy of controlling the temperature of the heater 90.

### 5. MODIFICATIONS

In the liquid ejecting apparatus 1 according to the present embodiment, the switch circuit 85 includes the switch element 851 and the switch element 852. In the temperature control period TM[j], the control circuit 83 controls the switch elements 851 and 852 such that the switch element 851 switches from the state in which the base drive signal bHC is not supplied to the heater 90 to the state in which the base drive signal bHC is supplied to the heater 90 and that the switch element 852 maintains the state in which the base drive signal bHC is not supplied to the heater 90. In the temperature control period TM[j+1] continuous to the temperature control period TM[j], the control circuit 83 controls the switch elements 851 and 852 such that the switch element 851 maintains the state in which the base drive signal bHC is not supplied to the heater 90 and that the switch element 852 switches from the state in which the base drive signal bHC is supplied to the heater 90 to the state in which the base drive signal bHC is not supplied to the heater 90. However, the switch circuit 85 may include only the switch element 851. In the temperature control period TM[j], the control circuit 83 may control the switch element 851 such that the switch element 851 switches from the state in which the base drive signal bHC is not supplied to the heater 90 to the state in which the base drive signal bHC is supplied to the heater 90. In the temperature control period TM[j+1] continuous to the temperature control period TM[j], the control circuit 83 may control the switch element 851 such that the switch element 851 switches from the state in which the base drive signal bHC is supplied to the heater 90 to the state in which the base drive signal bHC is not supplied to the heater 90. Even with such a configuration, similar operations and effects are obtained.

As described in the present embodiment, in the configuration in which the switch circuit 85 includes the switch element 851 and the switch element 852, it is possible to reduce the possibility that the amount of current flowing through the switch elements 851 and 852 may decrease and that the temperatures of the switch elements 851 and 852 may rise. On the other hand, as described in the modifications, in a case where the switch circuit 85 includes only the switch element 851, it is not necessary to dispose the switch element 852, and it is possible to make the switch circuit 85 and the heater driving unit 80 including the switch circuit 85 compact.

While the embodiments and the modifications are described above, the present disclosure is not limited to the embodiments and can be implemented in various aspects without departing from the concept of the present disclosure. For example, the above-described embodiments can also be combined with each other as appropriate.

The present disclosure includes substantially the same configurations (for example, configurations having the same functions, methods, and results as those described above, or configurations that achieve the same purposes and effects as those described above) as the configurations described in the embodiments. The present disclosure also includes configurations obtained by replacing non-essential sections of the configurations described in the embodiments. The present disclosure also includes configurations that achieve the same operations and effects as those of the configurations described in the embodiments or configurations that can achieve the same purposes as those of the configurations described in the embodiments. The present disclosure also includes configurations obtained by adding a known technology to the configurations described in the embodiments.

The following contents are derived from the above-described embodiments.

A liquid ejecting apparatus according to an aspect includes a transport unit that transports a medium; a print head that ejects liquid onto the medium; a heating circuit that heats the medium; a detection circuit that detects a temperature of the heating circuit; and a supply circuit that supplies driving power to the heating circuit in accordance with a result of the detection by the detection circuit, wherein the supply circuit includes a switch circuit that switches whether to supply the driving power to the heating circuit, and a switching control circuit that controls the switch circuit in accordance with the result of the detection in each of a plurality of control periods, and the switching control circuit switches the switch circuit from a state in which the driving power is not supplied to the heating circuit to a state in which the driving power is supplied to the heating circuit in a first control period among the plurality of control periods, and switches the switch circuit from the state in which the driving power is supplied to the heating circuit to the state in which the driving power is not supplied to the heating circuit in a second control period that is among the plurality of control periods and is continuous to the first control period.

According to the liquid ejecting apparatus, in the first control period among the plurality of control periods, the switching control circuit switches the switch circuit from the state in which the driving power is not supplied to the heating circuit to the state in which the driving power is supplied to the heating circuit, and in the second control period that is among the plurality of control periods and is continuous to the first control period, the switching control circuit switches the switch circuit from the state in which the driving power is supplied to the heating circuit to the state in which the driving power is not supplied to the heating circuit, and thus the state in which the driving power is supplied to the heating circuit in the first control period and the state in which the driving power is supplied to the heating circuit in the second control period are continuous. Thus, a period of supply of a signal corresponding to a power supply voltage to the heating circuit is longer than each of the control periods. Therefore, a period of a fluctuation in a voltage value of commercial power supplied to the liquid ejecting apparatus is longer than each of the control periods. As a result, even if a flicker occurs in a lighting apparatus coupled to a power supply system to which a commercial power supply that supplies the commercial power to the liquid ejecting apparatus is coupled, the possibility that a person may feel discomfort due to the flicker is reduced.

In the liquid ejecting apparatus according to the aspect, the switch circuit may include a first switch circuit that switches whether to supply the driving power to the heating circuit, and a second switch circuit that switches whether to supply the driving power to the heating circuit, in the first control period, the first switch circuit may switch from a state in which the driving power is not supplied to the heating circuit to a state in which the driving power is supplied to the heating circuit, and the second switch circuit may maintain a state in which the driving power is not supplied to the heating circuit, and in the second control period, the first switch circuit may maintain the state in which the driving power is not supplied to the heating circuit, and the second switch circuit may switch from a state in which the driving power is supplied to the heating circuit to the state in which the driving power is not supplied to the heating circuit.

According to the liquid ejecting apparatus, since the switch circuit includes the first switch circuit and the second switch circuit, the first switch circuit supplies the driving power to the heating circuit in the first control period, and the second switch circuit supplies the driving power to the heating circuit in the second control period, it is possible to reduce the possibility that the amounts of heat generated by the first switch circuit and the second switch circuit may decrease and that the temperatures of the first switch circuit and the second switch circuit may rise.

In the liquid ejecting apparatus according to the aspect, an electrical potential of a signal supplied to the heating circuit in a period of time when the switch circuit does not supply the driving power to the heating circuit in the first control period may be substantially equal to an electrical potential of a signal supplied to the heating circuit in a period of time when the switch circuit does not supply the driving power to the heating circuit in the second control period.

In the liquid ejecting apparatus according to the aspect, a signal waveform of a signal supplied to the heating circuit in a period of time when the switch circuit supplies the driving power to the heating circuit in the first control period and a signal waveform of a signal supplied to the heating circuit in a period of time when the switch circuit supplies the driving power to the heating circuit in the second control period may be continuous.

According to the liquid ejecting apparatus, it is possible to reduce the possibility that a difference may occur between the amount of current drawn into the liquid ejecting apparatus in the first control period in which the switch circuit supplies the driving power to the heating circuit and the amount of current drawn into the liquid ejecting apparatus in the second control period in which the switch circuit supplies the driving power to the heating circuit. Therefore, when the first control period transitions to the second control period, the possibility that the voltage value of the commercial power supplied to the liquid ejecting apparatus may fluctuate is reduced. Therefore, as a result, even if a flicker occurs in the lighting apparatus coupled to the power supply system to which the commercial power supply that supplies the commercial power to the liquid ejecting apparatus is coupled, the possibility that a person may feel discomfort due to the flicker is reduced.

In the liquid ejecting apparatus according to the aspect, the switching control circuit may control, in accordance with the result of the detection, a ratio of a length of a period of time when the switch circuit supplies the driving power to the heating circuit to a length of each of the plurality of control periods.

According to the liquid ejecting apparatus, it is possible to control the temperature of the heating circuit with high accuracy even in a case where each of the control periods is set to a constant period.

In the liquid ejecting apparatus according to the aspect, when the driving power is supplied to the heating circuit that heats the medium, a period of a voltage fluctuation that occurs in commercial power may be twice a length of each of the plurality of control periods.

According to the liquid ejecting apparatus, since the period of the fluctuation in the voltage value of the commercial power supplied to the liquid ejecting apparatus is twice each of the control periods, even if a flicker occurs in the lighting apparatus coupled to the power supply system to which the commercial power supply that supplies the commercial power to the liquid ejecting apparatus is coupled, the possibility that a person may feel discomfort due to the flicker is reduced.

In the liquid ejecting apparatus according to the aspect, the heating circuit may be positioned upstream of the print head and along a transport path for the medium transported by the transport unit.

In the liquid ejecting apparatus according to the aspect, the heating circuit may be positioned such that at least a portion of the heating circuit overlaps the print head as viewed from a direction orthogonal to a transport path for the medium transported by the transport unit.

In the liquid ejecting apparatus according to the aspect, the heating circuit may be positioned downstream of the print head and along a transport path for the medium transported by the transport unit.

In the liquid ejecting apparatus according to the aspect, each of the plurality of control periods may be a period longer than or equal to one second.

A method of controlling a heating circuit that heats a medium in a liquid ejecting apparatus that ejects liquid onto the medium according to an aspect includes: detecting a temperature of the heating circuit; and supplying driving power to the heating circuit in accordance with a result of the detecting in each of a plurality of control periods, wherein the supplying includes first supplying in which a state in which the driving power is not supplied to the heating circuit is switched to a state in which the driving power is supplied to the heating circuit in a first control period among the plurality of control periods, and second supplying in which the state in which the driving power is supplied to the heating circuit is switched to the state in which the driving power is not supplied to the heating circuit in a second control period that is among the plurality of control periods and is continuous to the first control period.

According to the method of controlling the heating circuit, in the first control period among the plurality of control periods, the state in which the driving power is not supplied to the heating circuit is switched to the state in which the driving power is supplied to the heating circuit, and in the second control period that is among the plurality of control periods and is continuous to the first control period, the state in which the driving power is supplied to the heating circuit is switched to the state in which the driving power is not supplied to the heating circuit, and thus the state in which the driving power is supplied to the heating circuit in the first control period and the state in which the driving power is supplied to the heating circuit in the second control period are continuous. Thus, a period of supply of a signal corresponding to a power supply voltage to the heating circuit is longer than each of the control periods. Therefore, a period of a fluctuation in a voltage value of commercial power supplied to the liquid ejecting apparatus is longer than each of the control periods. As a result, even if a flicker occurs in a lighting apparatus coupled to a power supply system to which a commercial power supply that supplies the commercial power to the liquid ejecting apparatus is coupled, the possibility that a person may feel discomfort due to the flicker is reduced.

What is claimed is:

1. A liquid ejecting apparatus comprising:
a transport unit that transports a medium;
a print head that ejects liquid onto the medium;
a heating circuit that heats the medium;
a detection circuit that detects a temperature of the heating circuit; and
a supply circuit that supplies driving power to the heating circuit in accordance with a result of the detection by the detection circuit, wherein
the supply circuit includes
a switch circuit that switches whether to supply the driving power to the heating circuit, and
a switching control circuit that controls the switch circuit in accordance with the result of the detection in each of a plurality of control periods,
the switching control circuit
switches the switch circuit from a state in which the driving power is not supplied to the heating circuit to a state in which the driving power is supplied to the heating circuit in a first control period among the plurality of control periods, and
switches the switch circuit from the state in which the driving power is supplied to the heating circuit to the state in which the driving power is not supplied to the heating circuit in a second control period that is among the plurality of control periods and is continuous to the first control period.

2. The liquid ejecting apparatus according to claim 1, wherein
the switch circuit includes a first switch circuit that switches whether to supply the driving power to the heating circuit, and a second switch circuit that switches whether to supply the driving power to the heating circuit,
in the first control period, the first switch circuit switches from a state in which the driving power is not supplied to the heating circuit to a state in which the driving power is supplied to the heating circuit, and the second switch circuit maintains a state in which the driving power is not supplied to the heating circuit, and
in the second control period, the first switch circuit maintains the state in which the driving power is not supplied to the heating circuit, and the second switch circuit switches from a state in which the driving power is supplied to the heating circuit to the state in which the driving power is not supplied to the heating circuit.

3. The liquid ejecting apparatus according to claim 1, wherein
an electrical potential of a signal supplied to the heating circuit in a period of time when the switch circuit does not supply the driving power to the heating circuit in the first control period is substantially equal to an electrical potential of a signal supplied to the heating circuit in a period of time when the switch circuit does not supply the driving power to the heating circuit in the second control period.

4. The liquid ejecting apparatus according to claim 1, wherein
a signal waveform of a signal supplied to the heating circuit in a period of time when the switch circuit supplies the driving power to the heating circuit in the first control period, and a signal waveform of a signal supplied to the heating circuit in a period of time when the switch circuit supplies the driving power to the heating circuit in the second control period are continuous.

5. The liquid ejecting apparatus according to claim 1, wherein
the switching control circuit controls, in accordance with the result of the detection, a ratio of a length of a period of time when the switch circuit supplies the driving power to the heating circuit to a length of each of the plurality of control periods.

6. The liquid ejecting apparatus according to claim 1, wherein
when the driving power is supplied to the heating circuit that heats the medium, a period of a voltage fluctuation that occurs in commercial power is twice a length of each of the plurality of control periods.

7. The liquid ejecting apparatus according to claim 1, wherein
the heating circuit is positioned upstream of the print head and along a transport path for the medium transported by the transport unit.

8. The liquid ejecting apparatus according to claim 1, wherein
the heating circuit is positioned such that at least a portion of the heating circuit overlaps the print head as viewed from a direction orthogonal to a transport path for the medium transported by the transport unit.

9. The liquid ejecting apparatus according to claim 1, wherein
the heating circuit is positioned downstream of the print head and along a transport path for the medium transported by the transport unit.

10. The liquid ejecting apparatus according to claim 1, wherein
each of the plurality of control periods is a period longer than or equal to one second.

11. A method of controlling a heating circuit that heats a medium in a liquid ejecting apparatus that ejects liquid onto the medium, the method comprising:
detecting a temperature of the heating circuit; and
supplying driving power to the heating circuit in accordance with a result of the detecting in each of a plurality of control periods, wherein
the supplying includes
first supplying in which a state in which the driving power is not supplied to the heating circuit is switched to a state in which the driving power is supplied to the heating circuit in a first control period among the plurality of control periods, and
second supplying in which the state in which the driving power is supplied to the heating circuit is switched to the state in which the driving power is not supplied to the heating circuit in a second control period that is among the plurality of control periods and is continuous to the first control period.
